(19) United States
(12) Patent Application Publication
(10) Pub. No.: US 2020/0220724 A1
(43) Pub. Date: Jul. 9, 2020

(54) KEY MANAGEMENT DEVICE, AND COMMUNICATION APPARATUS

(71) Applicant: MITSUBISHI ELECTRIC CORPORATION, Tokyo (JP)

(72) Inventor: Masamichi TANJI, Tokyo (JP)

(73) Assignee: MITSUBISHI ELECTRIC CORPORATION, Tokyo (JP)

(21) Appl. No.: 16/625,389

(22) PCT Filed: Aug. 21, 2017
(86) PCT No.: PCT/JP2017/029762

§ 371 Date: Dec. 20, 2019

(51) Int. Cl. H04L 9/30; H04L 9/08

(52) U.S. Cl. CPC H04L 9/30; H04L 9/088

(57) ABSTRACT

A reception unit receives a key request including a communication apparatus identifier and a terminal apparatus identifier. An apparatus key generation unit generates a communication apparatus key using the communication apparatus identifier included in the key request, and generates a terminal apparatus key using the terminal apparatus identifier included in the key request. A shared key generation unit generates an encrypted shared key of the communication apparatus by encrypting a shared key using the generated communication apparatus key, and generates an encrypted shared key of the terminal apparatus by encrypting the shared key using the generated terminal apparatus key. A transmission unit transmits a key reply including the encrypted shared key of the communication apparatus and the encrypted shared key of the terminal apparatus.

### TECHNICAL FIELD

The present invention relates to a technique for sharing a key.

### BACKGROUND ART

In the automobile industry, various driving support functions such as an automatic braking function and a lane keeping function have been developed to realize autonomous driving in the 2020s. The developed driving support functions are mounted in an automobile.

It is expected that more advanced driving support functions will be realized in the future where an automobile communicates with various external devices such as the cloud, roadside devices, and other automobiles.

When an automobile communicates with the outside, a possibility increases that the automobile will receive a malicious attack. Therefore, communication security is crucial.

Non-Patent Literature 1 proposes a method of performing authentication as technology related to communication security.

This method assumes a situation in which a transmission device and a reception device share common keys in advance for mutual authentication.

However, since an automobile is manufactured by assembling in-vehicle apparatuses made by various manufacturers, it is not easy for each manufacturer to grasp the communication relationship of the in-vehicle apparatuses in advance. Therefore, it is difficult to set a key in an in-vehicle apparatus when manufacturing the in-vehicle apparatus. In addition, since the in-vehicle apparatus may be replaced during operation, merely setting a key in the in-vehicle apparatus at the time of manufacture is not sufficient.

Patent Literature 1 proposes a method of distributing a key using public key cryptography.

However, since cost and resource restrictions are imposed on in-vehicle apparatuses, an in-vehicle apparatus that does not support public key cryptography exists. For this reason, it is difficult to apply the method of Patent Literature 1 to all in-vehicle apparatuses.

Patent Literature 2 proposes a method for apparatuses not sharing common keys in advance for authentication to share common keys securely by common key cryptography.

If the method of Patent Literature 2 is adopted, it is possible for a gateway existing in a vehicle of an automobile to implement authentication with respect to an in-vehicle apparatus being under the control of the gateway, for example in accordance with the following procedure of (1) to (6).

(1) The gateway receives a manufacturer ID (identifier) and an apparatus ID from the in-vehicle apparatus.

(2) The gateway passes the manufacturer ID and the apparatus ID of the in-vehicle apparatus to a management server.

(3) The management server holds a master key and regenerates a manufacturer authentication key using the master key and the manufacturer ID of the in-vehicle apparatus.

(4) The management server regenerates an apparatus authentication key using the regenerated manufacturer authentication key and the apparatus ID of the in-vehicle apparatus.

(5) The management server transmits the regenerated apparatus authentication key to the gateway.

(6) The gateway receives the apparatus authentication key and performs mutual authentication with the in-vehicle apparatus using the received apparatus authentication key.

With the above procedure, in an automobile incorporating in-vehicle apparatuses made by various manufacturers, the gateway can achieve mutual authentication with each in-vehicle apparatus even if the gateway does not share an authentication key with that in-vehicle apparatus in advance.

In addition, since the common key cryptography is used in this method, this method can be applied to all in-vehicle apparatuses.

In the method of Patent Literature 2, the following two timings are possible as timings at which the gateway shares the common key with an in-vehicle apparatus. One timing is when assembling an automobile at an automobile manufacturer's factory. At this time, the gateway does not share a common key with any in-vehicle apparatus. Therefore, the gateway performs key sharing processing with all in-vehicle apparatuses.

The other timing is when a dealer or the like adds a new in-vehicle apparatus to an automobile or replaces an existing in-vehicle apparatus. In these cases, the gateway already shares a common key with respect to the in-vehicle apparatus mounted in the automobile. Therefore, the gateway performs key sharing processing with a newly added in-vehicle apparatus.

### CITATION LIST

### Patent Literature

Patent Literature 1: JP 2004-259262 A
Patent Literature 2: Japanese Patent No. 5992104

### Non-Patent Literature

Non-Patent Literature 1: AUTOSAR, Specification of Module Secure Onboard Communication, Release 4.2.2

### SUMMARY OF INVENTION

### Technical Problem

In recent years, the number of in-vehicle apparatuses mounted in an automobile has increased, and there are cases where one hundred or more in-vehicle apparatuses are mounted in one automobile.

When the method of Patent Literature 2 is applied, in order to realize key sharing between the gateway and all vehicle apparatuses in the automobile when assembling an automobile at a factory of an automobile manufacturer, it is necessary to perform the above procedure of (1) to (6) repeatedly a number of times equal to the number of in-vehicle apparatuses.

Consequently, the number of communication packets exchanged between the gateway and a management server increases, and the processing time required for key sharing between the gateway and all vehicle apparatuses increases.

In the assembly of an automobile at a factory, reduction of working time is strongly demanded.

Also, a management server needs to manage a master key strictly. Therefore, it is desirable that the management server be installed only at one location in the automobile manufacturer instead of at each factory, and that the master key be centrally managed. Accordingly, the management server needs to respond to key requests from all production lines of all factories of the automobile manufacturer. Consequently, reduction of processing load on the management server is also strongly required.

It is an objective of the present invention to enable reduction of an amount of data exchanged between a gateway (communication apparatus) and a key management device in order for the gateway to share a key with each in-vehicle apparatus (terminal apparatus).

### Solution to Problem

A key management device according to the present invention includes:

a reception unit to receive a key request including: a communication apparatus identifier which identifies a communication apparatus; and a terminal apparatus identifier which identifies a terminal apparatus;

an apparatus key generation unit to generate a communication apparatus key corresponding to the communication apparatus identifier using the communication apparatus identifier included in the key request, and to generate a terminal apparatus key corresponding to the terminal apparatus identifier using the terminal apparatus identifier included in the key request;

a shared key encryption unit to generate an encrypted shared key of the communication apparatus by encrypting a shared key, shared by the communication apparatus and the terminal apparatus, using the generated communication apparatus key, and to generate an encrypted shared key of the terminal apparatus by encrypting the shared key using the generated terminal apparatus key; and

a transmission unit to transmit a key reply including the encrypted shared key of the communication apparatus and the encrypted shared key of the terminal apparatus.

### Advantageous Effects of Invention

According to the present invention, it is possible to reduce an amount of data exchanged between a gateway (communication apparatus) and a key management device in order for the gateway to share a key with each in-vehicle apparatus (terminal apparatus). As a result, the processing time for key sharing can be shortened. Furthermore, in the key management device, the processing load resulting from key sharing can be reduced.

### BRIEF DESCRIPTION OF DRAWINGS

FIG. 1 is a configuration diagram of a key sharing system 10 in Embodiment 1.

FIG. 2 is a configuration diagram of a key management device 100 in Embodiment 1.

FIG. 3 is a configuration diagram of a storage unit 120 in Embodiment 1.

FIG. 4 is a configuration diagram of a first apparatus management device 200 in Embodiment 1.

FIG. 5 is a configuration diagram of a storage unit 220 in Embodiment 1.

FIG. 6 is a configuration diagram of a second apparatus management device 300 in Embodiment 1.

FIG. 7 is a configuration diagram of a storage unit 320 in Embodiment 1.

FIG. 8 is a configuration diagram of a third apparatus management device 400 in Embodiment 1.

FIG. 9 is a configuration diagram of a storage unit 420 in Embodiment 1.

FIG. 10 is a configuration diagram of a gateway 500 in Embodiment 1.

FIG. 11 is a configuration diagram of a storage unit 520 in Embodiment 1.

FIG. 12 is a configuration diagram of a first in-vehicle apparatus 600 in Embodiment 1.

FIG. 13 is a configuration diagram of a storage unit 620 in Embodiment 1.

FIG. 14 is a configuration diagram of a second in-vehicle apparatus 700 in Embodiment 1.

FIG. 15 is a configuration diagram of a storage unit 720 in Embodiment 1.

FIG. 16 is a configuration diagram of a third in-vehicle apparatus 800 in Embodiment 1.

FIG. 17 is a configuration diagram of a storage unit 820 in Embodiment 1.

FIG. 18 is a configuration diagram of a fourth in-vehicle apparatus 900 in Embodiment 1.

FIG. 19 is a configuration diagram of a storage unit 920 in Embodiment 1.

FIG. 20 is a flowchart of an apparatus key setting process in Embodiment 1.

FIG. 21 is a flowchart of a key sharing process in Embodiment 1.

FIG. 22 is a flowchart of an information request process (S110) in Embodiment 1.

FIG. 23 is a diagram illustrating an information request 20 in Embodiment 1.

FIG. 24 is a flowchart of an information transmission process (S120) in Embodiment 1.

FIG. 25 is a diagram illustrating an information reply 30 in Embodiment 1.

FIG. 26 is a diagram illustrating an information reply 40 in Embodiment 1.

FIG. 27 is a diagram illustrating an information reply 50 in Embodiment 1.

FIG. 28 is a diagram illustrating an information reply 60 in Embodiment 1.

FIG. 29 is a flowchart of a sort process (S130) in Embodiment 1.

FIG. 30 is a diagram illustrating sort information data 70 in Embodiment 1.

FIG. 31 is a flowchart of a key reply process (S150) in Embodiment 1.

FIG. 32 is a flowchart of step S156 in Embodiment 1.

FIG. 33 is a flowchart of an in-vehicle apparatus verification process (S200) in Embodiment 1.

FIG. 34 is a flowchart of a key decryption process (S190) in Embodiment 1.

FIG. 35 is a flowchart of an in-vehicle apparatus verification process (S200) in Embodiment 2.

FIG. 36 is a configuration diagram of a key management device 100 in Embodiment 4.

FIG. 37 is a configuration diagram of a gateway 500 in Embodiment 4.

FIG. 38 is a flowchart of a key sharing process in Embodiment 4.

FIG. 39 is a flowchart of a key reply process (S340) in Embodiment 4.

FIG. 40 is a hardware configuration diagram of the key management device 100 in Embodiments.

FIG. 41 is a hardware configuration diagram of the apparatus management device (200, 300, 400) in Embodiments.

FIG. 42 is a hardware configuration diagram of the gateway 500 in Embodiments.

FIG. 43 is a hardware configuration diagram of the in-vehicle apparatus (600, 700, 800, 900) in Embodiments.

### DESCRIPTION OF EMBODIMENTS

In Embodiments and drawings, the same elements and equivalent elements are denoted by the same reference numeral. Description of an element denoted by the same reference numeral is omitted or simplified appropriately. Arrows in the drawings mainly indicate flows of data or flows of processing.

### Embodiment 1

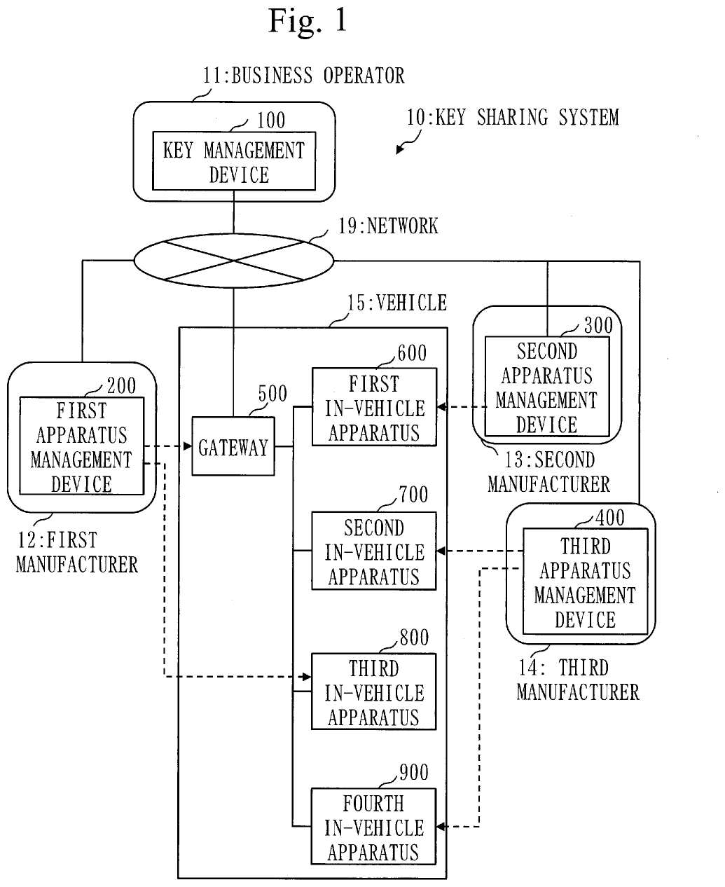

Modes for performing key sharing will be described with referring to FIG. 1 to FIG. 35.

A configuration of a key sharing system 10 will be described with referring to FIG. 1.

The key sharing system 10 is an example of a key sharing system.

The key sharing system 10 is provided with a key management device 100, a first apparatus management device 200, a second apparatus management device 300, and a third apparatus management device 400.

The key management device 100, the first apparatus management device 200, the second apparatus management device 300, and the third apparatus management device 400 communicate with each other via a network 19.

Furthermore, the key sharing system 10 is provided with a gateway 500, a first in-vehicle apparatus 600, a second in-vehicle apparatus 700, a third in-vehicle apparatus 800, and a fourth in-vehicle apparatus 900.

The gateway 500, the first in-vehicle apparatus 600, the second in-vehicle apparatus 700, the third in-vehicle apparatus 800, and the fourth in-vehicle apparatus 900 are apparatuses mounted in a vehicle 15.

The vehicle 15 is an automobile, and is an example of a product.

The gateway 500, the first in-vehicle apparatus 600, the second in-vehicle apparatus 700, the third in-vehicle apparatus 800, and the fourth in-vehicle apparatus 900 communicate with each other via a cable.

Furthermore, the gateway 500 communicates with the key management device 100, the first apparatus management device 200, the second apparatus management device 300, and the third apparatus management device 400 via the network 19.

The gateway 500 is a communication apparatus.

The first in-vehicle apparatus 600, the second in-vehicle apparatus 700, the third in-vehicle apparatus 800, and the fourth in-vehicle apparatus 900 are each a terminal apparatus.

The key management device 100 is a device owned by a business operator 11.

The business operator 11 is a manufacturer that manufactures the vehicle 15.

The first apparatus management device 200 is a device owned by a first manufacturer 12.

The first manufacturer 12 is a manufacturer that manufactures a first apparatus.

The first apparatus is an apparatus manufactured by the first manufacturer 12, and is mounted in the vehicle 15.

In the key sharing system 10, the first apparatus corresponds to each of the gateway 500 and the third in-vehicle apparatus 800.

Hence, the first manufacturer 12 is a communication manufacturer that manufactures a communication apparatus, and is a terminal manufacturer that manufactures a terminal apparatus.

The second apparatus management device 300 is a device owned by a second manufacturer 13.

The second manufacturer 13 is a manufacturer that manufactures a second apparatus.

The second apparatus is an apparatus manufactured by the second manufacturer 13, and is mounted in the vehicle 15.

In the key sharing system 10, the second apparatus is the first in-vehicle apparatus 600.

Hence, the second manufacturer 13 is a terminal manufacturer that manufactures a terminal apparatus.

The third apparatus management device 400 is a device owned by a third manufacturer 14.

The third manufacturer 14 is a manufacturer that manufactures a third apparatus.

The third apparatus is an apparatus manufactured by the third manufacturer 14, and is mounted in the vehicle 15.

In the key sharing system 10, the third apparatus corresponds to each of the second in-vehicle apparatus 700 and the fourth in-vehicle apparatus 900.

Hence, the third manufacturer 14 is a terminal manufacturer that manufactures a terminal apparatus.

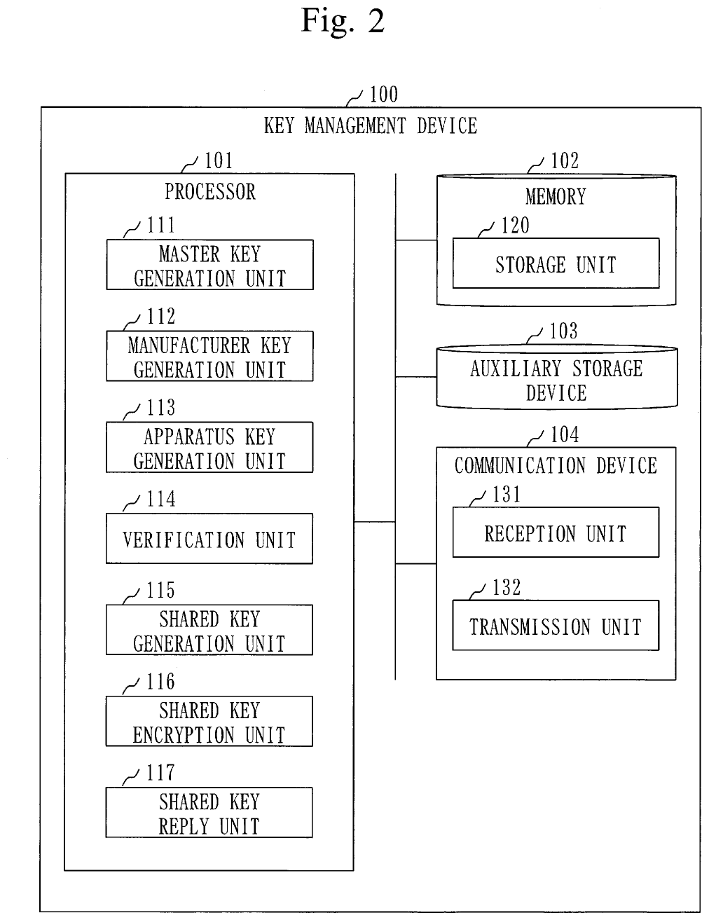

A configuration of the key management device 100 will be described with referring to FIG. 2.

The key management device 100 is a computer provided with hardware devices such as a processor 101, a memory 102, an auxiliary storage device 103, and a communication device 104. These hardware devices are connected to each other via a signal line.

The processor 101 is a processor provided to the key management device 100. The processor is an integrated circuit (IC) which performs arithmetic processing, and controls the other hardware devices.

The processor is, for example, a central processing unit (CPU), a digital signal processor (DSP), or a graphics processing unit (GPU).

The memory 102 is a memory provided to the key management device 100.

The memory is a volatile storage device and is called a main storage device or main memory as well.

The memory is, for example, a random access memory (RAM).

Data stored in the memory 102 is saved in the auxiliary storage device 103 as necessary.

The auxiliary storage device 103 is an auxiliary storage device provided to the key management device 100.

The auxiliary storage device is a non-volatile storage device.

The auxiliary storage device is, for example, a read only memory (ROM), a hard disk drive (HDD), or a flash memory.

Data stored in the auxiliary storage device 103 is loaded to the memory 102 as necessary.

The communication device 104 is a communication device provided to the key management device 100.

The communication device is a device that performs communication, that is, the communication device corresponds to a receiver and a transmitter.

The communication device is, for example, a communication chip or a network interface card (NIC).

The key management device 100 is provided with elements such as a master key generation unit 111, a manufacturer key generation unit 112, an apparatus key generation unit 113, a verification unit 114, a shared key generation unit 115, a shared key encryption unit 116, and a shared key reply unit 117. These elements are implemented by software.

A key management program for causing the computer to function as the master key generation unit 111, the manufacturer key generation unit 112, the apparatus key generation unit 113, the verification unit 114, the shared key generation unit 115, the shared key encryption unit 116, and the shared key reply unit 117 is stored in the auxiliary storage device 103. The key management program is loaded to the memory 102 and executed by the processor 101.

Furthermore, an operating system (OS) is stored in the auxiliary storage device 103. At least part of the OS is loaded to the memory 102 and executed by the processor 101.

That is, the processor 101 executes the key management program while executing the OS.

Data obtained by executing the key management program is stored in a storage device such as the memory 102, the auxiliary storage device 103, and a register in the processor 101 or a cache memory in the processor 101.

The memory 102 functions as a storage unit 120 that stores data. Alternatively, another storage device may function as the storage unit 120 in place of the memory 102 or along with the memory 102.

The communication device 104 functions as a reception unit 131 which receives data. Furthermore, the communication device 104 functions as a transmission unit 132 which transmits data.

The key management device 100 may be provided with a plurality of processors that replace the processor 101. The plurality of processors share the role of the processor 101.

The key management program can be computer-readably recorded in a non-volatile recording medium such as an optical disk and a flash memory.

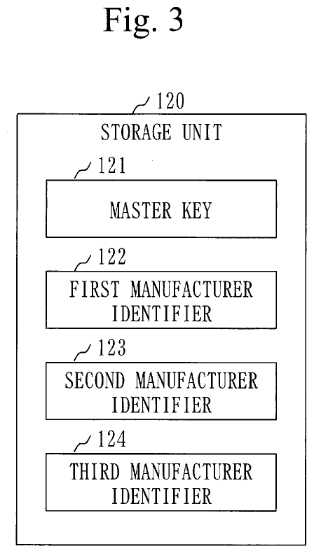

A configuration of the storage unit 120 will be described with referring to FIG. 3.

The storage unit 120 stores data such as a master key 121, a first manufacturer identifier 122, a second manufacturer identifier 123, and a third manufacturer identifier 124. A content of each data will be described later.

These pieces of data are major data stored in the storage unit 120. The data stored in the storage unit 120 is managed securely so as not to leak to the outside.

The master key 121, the first manufacturer identifier 122, the second manufacturer identifier 123, and the third manufacturer identifier 124 are stored in the auxiliary storage device 103 at the time they are generated. After that, at the time the key management device 100 is started, the master key 121, the first manufacturer identifier 122, the second manufacturer identifier 123, and the third manufacturer identifier 124 are read from the auxiliary storage device 103 and written in the storage unit 120 of the memory 102.

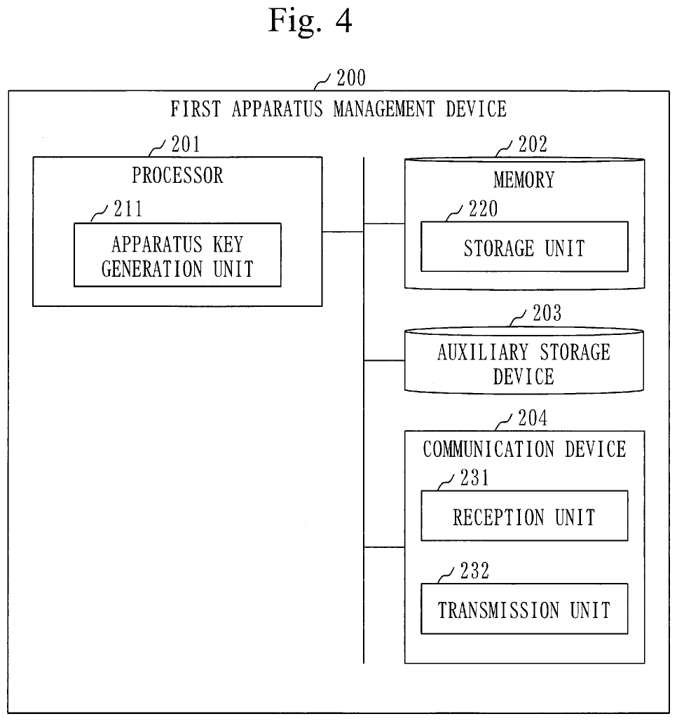

A configuration of the first apparatus management device 200 will be described with referring to FIG. 4.

The first apparatus management device 200 is a computer provided with hardware devices such as a processor 201, a memory 202, an auxiliary storage device 203, and a communication device 204. These hardware devices are connected to each other via a signal line.

The processor 201 is a processor provided to the first apparatus management device 200.

The memory 202 is a memory provided to the first apparatus management device 200. Data stored in the memory 202 is saved in the auxiliary storage device 203 as necessary.

The auxiliary storage device 203 is an auxiliary storage device provided to the first apparatus management device 200. Data stored in the auxiliary storage device 203 is loaded to the memory 202 as necessary.

The communication device 204 is a communication device provided to the first apparatus management device 200.

The first apparatus management device 200 is provided with an apparatus key generation unit 211. The apparatus key generation unit 211 is implemented by software.

A first apparatus management program to cause the computer to function as the apparatus key generation unit 211 is stored in the auxiliary storage device 203. The first apparatus management program is loaded to the memory 202 and executed by the processor 201.

Furthermore, an OS is stored in the auxiliary storage device 203. At least part of the OS is loaded to the memory 202 and executed by the processor 201.

That is, the processor 201 executes the first apparatus management program while executing the OS.

Data obtained by executing the first apparatus management program is stored in a storage device such as the memory 202, the auxiliary storage device 203, and a register in the processor 201 or a cache memory in the processor 201.

The memory 202 functions as a storage unit 220 that stores data. Alternatively, another storage device may function as the storage unit 220 in place of the memory 202 or along with the memory 202.

The communication device 204 functions as a reception unit 231 that receives data. Furthermore, the communication device 204 functions as a transmission unit 232 that transmits data.

The first apparatus management device 200 may be provided with a plurality of processors that replace the processor 201. The plurality of processors share the role of the processor 201.

The first apparatus management program can be computer-readably recorded in a non-volatile recording medium such as an optical disk and a flash memory.

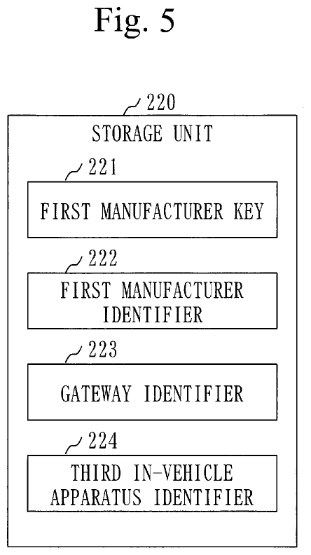

A configuration of the storage unit 220 will be described with referring to FIG. 5.

The storage unit 220 stores data such as a first manufacturer key 221, a first manufacturer identifier 222, a gateway identifier 223, and a third in-vehicle apparatus identifier 224. A content of each data will be described later.

These pieces of data are major data stored in the storage unit 220. The data stored in the storage unit 220 is managed securely so as not to leak to the outside.

The first manufacturer key 221, the first manufacturer identifier 222, the gateway identifier 223, and the third in-vehicle apparatus identifier 224 are stored in the auxiliary storage device 203 at the time they are received or generated. After that, at the time the first apparatus management device 200 is started, the first manufacturer key 221, the first manufacturer identifier 222, the gateway identifier 223, and the third in-vehicle apparatus identifier 224 are read from the auxiliary storage device 203 and written in the storage unit 220 of the memory 202.

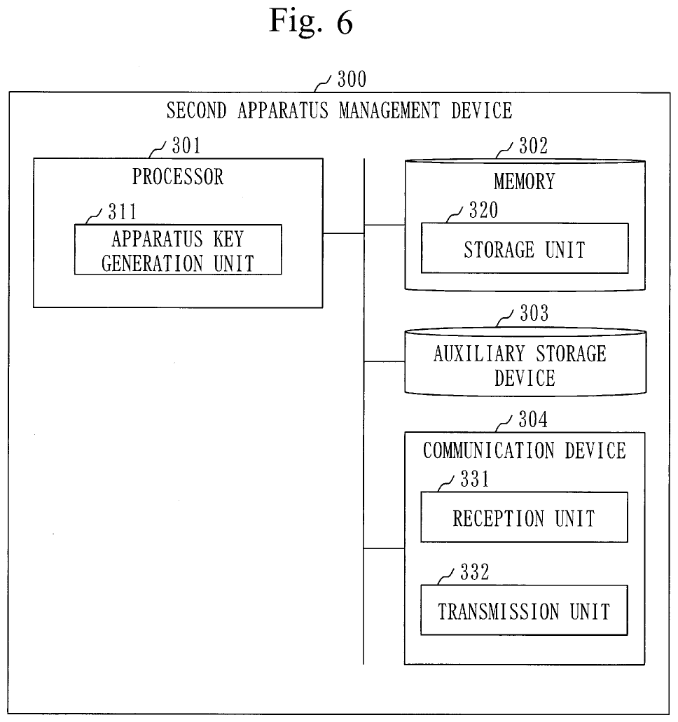

A configuration of the second apparatus management device 300 will be described with referring to FIG. 6.

The second apparatus management device 300 is a computer provided with hardware devices such as a processor 301, a memory 302, an auxiliary storage device 303, and a communication device 304. These hardware devices are connected to each other via a signal line.

The processor 301 is a processor provided to the second apparatus management device 300.

The memory 302 is a memory provided to the second apparatus management device 300. Data stored in the memory 302 is saved in the auxiliary storage device 303 as necessary.

The auxiliary storage device 303 is an auxiliary storage device provided to the second apparatus management device 300. Data stored in the auxiliary storage device 303 is loaded to the memory 302 as necessary.

The communication device 304 is a communication device provided to the second apparatus management device 300.

The second apparatus management device 300 is provided with an apparatus key generation unit 311. The apparatus key generation unit 311 is implemented by software.

A second apparatus management program to cause the computer to function as the apparatus key generation unit 311 is stored in the auxiliary storage device 303. The second apparatus management program is loaded to the memory 302 and executed by the processor 301.

Furthermore, an OS is stored in the auxiliary storage device 303. At least part of the OS is loaded to the memory 302 and executed by the processor 301.

That is, the processor 301 executes the second apparatus management program while executing the OS.

Data obtained by executing the second apparatus management program is stored in a storage device such as the memory 302, the auxiliary storage device 303, and a register in the processor 301 or a cache memory in the processor 301.

The memory 302 functions as a storage unit 320 that stores data. Alternatively, another storage device may function as the storage unit 320 in place of the memory 302 or along with the memory 302.

The communication device 304 functions as a reception unit 331 that receives data. Furthermore, the communication device 304 functions as a transmission unit 332 that transmits data.

The second apparatus management device 300 may be provided with a plurality of processors that replace the processor 301. The plurality of processors share the role of the processor 301.

The second apparatus management program can be computer-readably recorded in a non-volatile recording medium such as an optical disk and a flash memory.

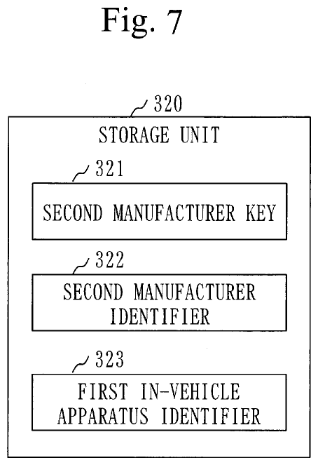

A configuration of the storage unit 320 will be described with referring to FIG. 7.

The storage unit 320 stores data such as a second manufacturer key 321, a second manufacturer identifier 322, and a first in-vehicle apparatus identifier 323. A content of each data will be described later.

These pieces of data are major data stored in the storage unit 320. The data stored in the storage unit 320 is managed securely so as not to leak to the outside.

The second manufacturer key 321, the second manufacturer identifier 322, and the first in-vehicle apparatus identifier 323 are stored in the auxiliary storage device 203 at the time they are received or generated. After that, the second manufacturer key 321, the second manufacturer identifier 322, and the first in-vehicle apparatus identifier 323 are read from the auxiliary storage device 303 and written in the storage unit 320 of the memory 302.

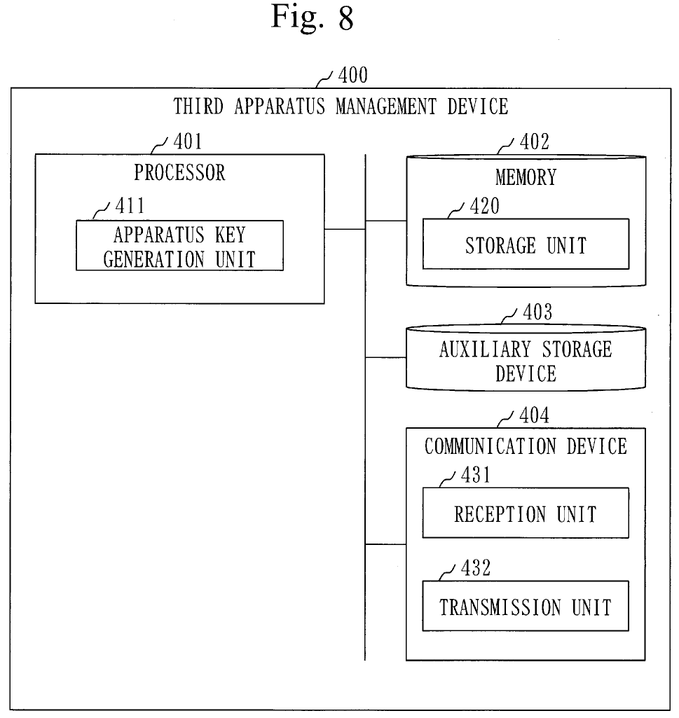

A configuration of the third apparatus management device 400 will be described with referring to FIG. 8.

The third apparatus management device 400 is a computer provided with hardware devices such as a processor 401, a memory 402, an auxiliary storage device 403, and a communication device 404. These hardware devices are connected to each other via a signal line.

The processor 401 is a processor provided to the third apparatus management device 400.

The memory 402 is a memory provided to the third apparatus management device 400. Data stored in the memory 402 is saved in the auxiliary storage device 403 as necessary.

The auxiliary storage device 403 is an auxiliary storage device provided to the third apparatus management device 400. Data stored in the auxiliary storage device 403 is loaded to the memory 402 as necessary.

The communication device 404 is a communication device provided to the third apparatus management device 400.

The third apparatus management device 400 is provided with an apparatus key generation unit 411. The apparatus key generation unit 411 is implemented by software.

A third apparatus management program to cause the computer to function as the apparatus key generation unit 411 is stored in the auxiliary storage device 403. The third apparatus management program is loaded to the memory 402 and executed by the processor 401.

Furthermore, an OS is stored in the auxiliary storage device 403. At least part of the OS is loaded to the memory 402 and executed by the processor 401.

That is, the processor 401 executes the third apparatus management program while executing the OS.

Data obtained by executing the third apparatus management program is stored in a storage device such as the memory 402, the auxiliary storage device 403, or a register in the processor 401 or a cache memory in the processor 401.

The memory 402 functions as a storage unit 420 that stores data. Alternatively, another storage device may function as the storage unit 420 in place of the memory 402 or along with the memory 402.

The communication device 404 functions as a reception unit 431 that receives data. Furthermore, the communication device 404 functions as a transmission unit 432 that transmits data.

The third apparatus management device 400 may be provided with a plurality of processors that replace the processor 401. The plurality of processors share the role of the processor 401.

The third apparatus management program can be computer-readably recorded in a non-volatile recording medium such as an optical disk and a flash memory.

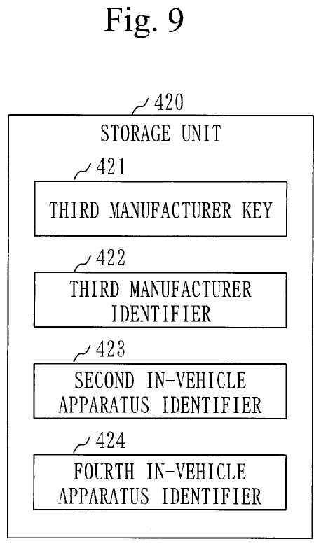

A configuration of the storage unit 420 will be described with referring to FIG. 9.

The storage unit 420 stores data such as a third manufacturer key 421, a third manufacturer identifier 422, a second in-vehicle apparatus identifier 423, and a fourth in-vehicle apparatus identifier 424. A content of each data will be described later.

These pieces of data are major data stored in the storage unit 420. The data stored in the storage unit 420 is managed securely so as not to leak to the outside.

The third manufacturer key 421, the third manufacturer identifier 422, the second in-vehicle apparatus identifier 423, and the fourth in-vehicle apparatus identifier 424 are stored in the auxiliary storage device 403 at the time they are received or generated. After that, at the time the third apparatus management device 400 is started, the third manufacturer key 421, the third manufacturer identifier 422, the second in-vehicle apparatus identifier 423, and the fourth in-vehicle apparatus identifier 424 are read from the auxiliary storage device 403 and written in the storage unit 420 of the memory 402.

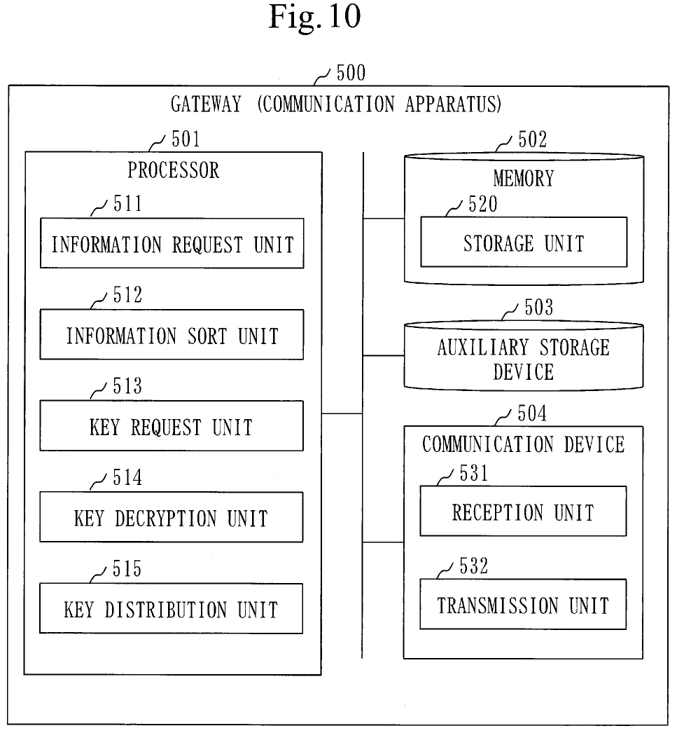

A configuration of the gateway 500 will be described with referring to FIG. 10.

The gateway 500 is a computer provided with hardware devices such as a processor 501, a memory 502, an auxiliary storage device 503, and a communication device 504. These hardware devices are connected to each other via a signal line.

The processor 501 is a processor provided to the gateway 500.

The memory 502 is a memory provided to the gateway 500. Data stored in the memory 502 is saved in the auxiliary storage device 503 as necessary.

The auxiliary storage device 503 is an auxiliary storage device provided to the gateway 500. Data stored in the auxiliary storage device 503 is loaded to the memory 502 as necessary.

The communication device 504 is a communication device provided to the gateway 500.

The gateway 500 is provided with elements such as an information request unit 511, an information sort unit 512, a key request unit 513, a key decryption unit 514, and a key distribution unit 515. These elements are implemented by software.

A communication apparatus program to cause the computer to function as the information request unit 511, the information sort unit 512, the key request unit 513, the key decryption unit 514, and the key distribution unit 515 is stored in the auxiliary storage device 503. The communication apparatus program is loaded to the memory 502 and executed by the processor 501.

Furthermore, an OS is stored in the auxiliary storage device 503. At least part of the OS is loaded to the memory 502 and executed by the processor 501.

That is, the processor 501 executes the communication apparatus program while executing the OS.

Data obtained by executing the communication apparatus program is stored in a storage device such as the memory 502, the auxiliary storage device 503, and a register in the processor 501 or a cache memory in the processor 501.

The memory 502 functions as a storage unit 520 that stores data. Alternatively, another storage device may function as the storage unit 520 in place of the memory 502 or along with the memory 502.

The communication device 504 functions as a reception unit 531 that receives data. Furthermore, the communication device 504 functions as a transmission unit 532 that transmits data.

The gateway 500 may be provided with a plurality of processors that replace the processor 501. The plurality of processors share the role of the processor 501.

The communication apparatus program can be computer-readably recorded in a non-volatile recording medium such as an optical disk and a flash memory.

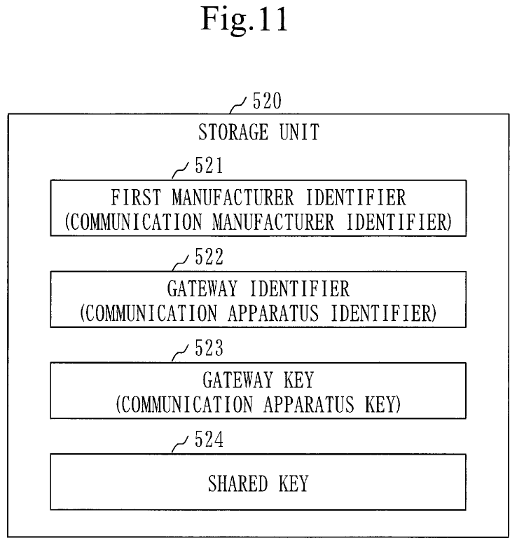

A configuration of the storage unit 520 will be described with referring to FIG. 11.

The storage unit 520 stores data such as a first manufacturer identifier 521, a gateway identifier 522, a gateway key 523, and a shared key 524. A content of each data will be described later.

These pieces of data are major data stored in the storage unit 520. The data stored in the storage unit 520 is managed securely so as not to leak to the outside.

The first manufacturer identifier 521, the gateway identifier 522, the gateway key 523, and the shared key 524 are stored in the auxiliary storage device 503 at the time they are received or decrypted. After that, at the time the gateway 500 is started, the first manufacturer identifier 521, the gateway identifier 522, the gateway key 523, and the shared key 524 are read from the auxiliary storage device 503 and written in the storage unit 520 of the memory 502.

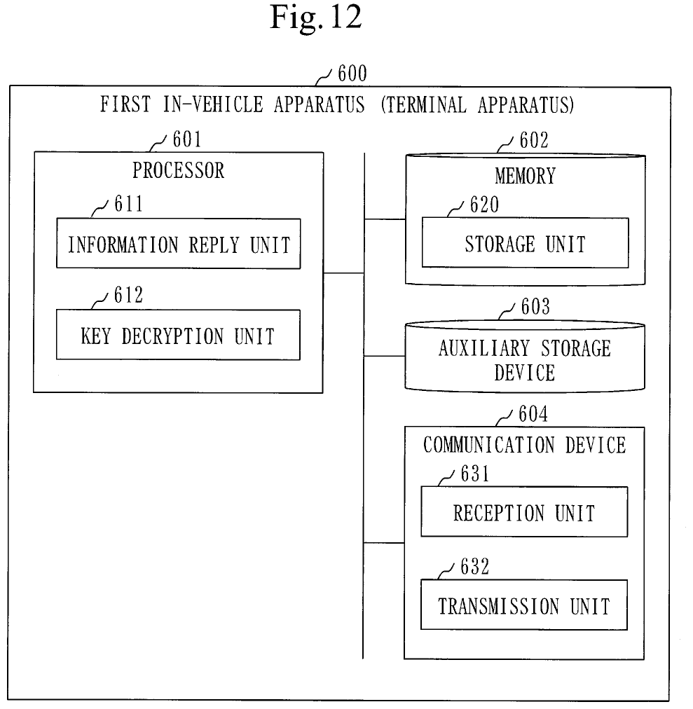

A configuration of the first in-vehicle apparatus 600 will be described with referring to FIG. 12.

The first in-vehicle apparatus 600 is a computer provided with hardware devices such as a processor 601, a memory 602, an auxiliary storage device 603, and a communication device 604. These hardware devices are connected to each other via a signal line.

The processor 601 is a processor provided to the first in-vehicle apparatus 600.

The memory 602 is a memory provided to the first in-vehicle apparatus 600. The data stored in the memory 602 is saved in the auxiliary storage device 603 as necessary. The auxiliary storage device 603 is an auxiliary storage device provided to the first in-vehicle apparatus 600. The data stored in the auxiliary storage device 603 is loaded to the memory 602 as necessary.

The communication device 604 is a communication device provided to the first in-vehicle apparatus 600.

The first in-vehicle apparatus 600 is provided with elements such as an information reply unit 611 and a key decryption unit 612. These elements are implemented by software.

A first terminal apparatus program to cause the computer to function as the information reply unit 611 and the key decryption unit 612 is stored in the auxiliary storage device 603. The first terminal apparatus program is loaded to the memory 602 and executed by the processor 601.

Furthermore, an OS is stored in the auxiliary storage device 603. At least part of the OS is loaded to the memory 602 and executed by the processor 601.

That is, the processor 601 executes the first terminal apparatus program while executing the OS.

Data obtained by executing the first terminal apparatus program is stored in a storage device such as the memory 602, the auxiliary storage device 603, and a register in the processor 601 or a cache memory in the processor 601.

The memory 602 functions as a storage unit 620 that stores data. Alternatively, another storage device may function as the storage unit 620 in place of the memory 602 or along with the memory 602.

The communication device 604 functions as a reception unit 631 that receives data. Furthermore, the communication device 604 functions as a transmission unit 632 that transmits data.

The first in-vehicle apparatus 600 may be provided with a plurality of processors that replace the processor 601. The plurality of processors share the role of the processor 601.

The first terminal apparatus program can be computer-readably stored in a non-volatile recording medium such as an optical disk and a flash memory.

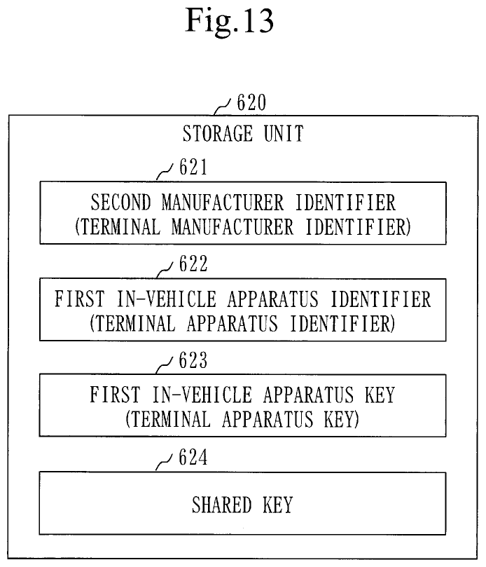

A configuration of the storage unit 620 will be described with referring to FIG. 13.

The storage unit 620 stores data such as a second manufacturer identifier 621, a first in-vehicle apparatus identifier 622, a first in-vehicle apparatus key 623, and a shared key 624. A content of each data will be described later.

These pieces of data are major data stored in the storage unit 620. The data stored in the storage unit 620 is managed securely so as not to leak to the outside.

The second manufacturer identifier 621, the first in-vehicle apparatus identifier 622, the first in-vehicle apparatus key 623, and the shared key 624 are stored in the auxiliary storage device 603 at the time they are received or decrypted. After that, at the time the first in-vehicle apparatus 600 is started, the second manufacturer identifier 621, the first in-vehicle apparatus identifier 622, the first in-vehicle apparatus key 623, and the shared key 624 are read from the auxiliary storage device 603 and written in the storage unit 620 of the memory 602.

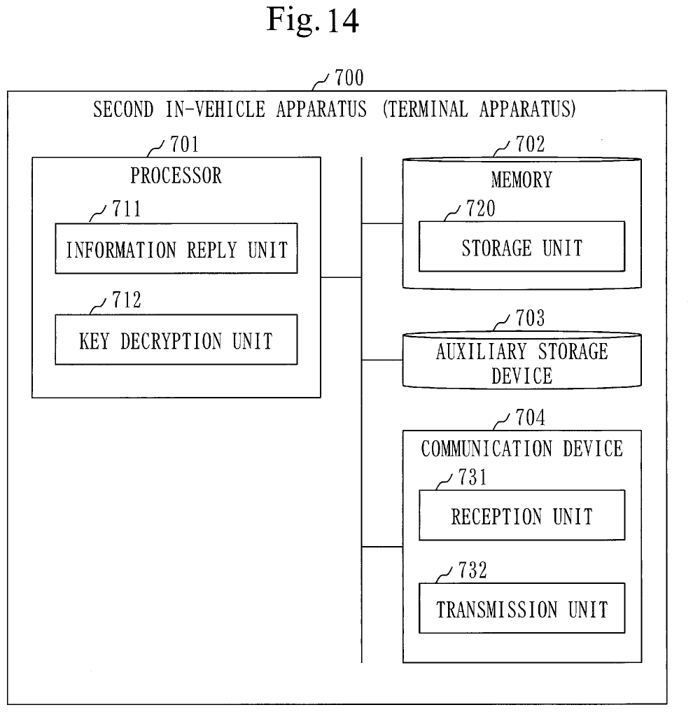

A configuration of the second in-vehicle apparatus 700 will be described with referring to FIG. 14.

The second in-vehicle apparatus 700 is a computer provided with hardware devices such as a processor 701, a memory 702, an auxiliary storage device 703, and a communication device 704. These hardware devices are connected to each other via a signal line.

The processor 701 is a processor provided to the second in-vehicle apparatus 700.

The memory 702 is a memory provided to the second in-vehicle apparatus 700. Data stored in the memory 702 is saved in the auxiliary storage device 703 as necessary.

The auxiliary storage device 703 is an auxiliary storage device provided to the second in-vehicle apparatus 700. Data stored in the auxiliary storage device 703 is loaded to the memory 702 as necessary.

The communication device 704 is a communication device provided to the second in-vehicle apparatus 700.

The second in-vehicle apparatus 700 is provided with elements such as an information reply unit 711 and a key decryption unit 712. These elements are implemented by software.

A second terminal apparatus program to cause the computer to function as the information reply unit 711 and the key decryption unit 712 is stored in the auxiliary storage device 703. The second terminal apparatus program is loaded to the memory 702 and executed by the processor 701.

Furthermore, an OS is stored in the auxiliary storage device 703. At least part of the OS is loaded to the memory 702 and executed by the processor 701.

That is, the processor 701 executes the second terminal apparatus program while executing the OS.

Data obtained by executing the second terminal apparatus program is stored in a storage device such as the memory 702, the auxiliary storage device 703, and a register in the processor 701 or a cache memory in the processor 701.

The memory 702 functions as a storage unit 720 that stores data. Alternatively, another storage device may function as the storage unit 720 in place of the memory 702 or along with the memory 702.

The communication device 704 functions as a reception unit 731 that receives data. Furthermore, the communication device 704 functions as a transmission unit 732 that transmits data.

The second in-vehicle apparatus 700 may be provided with a plurality of processors that replace the processor 701. The plurality of processors share the role of the processor 701.

The second terminal apparatus program can be computer-readably recorded in a non-volatile recording medium such as an optical disk and a flash memory.

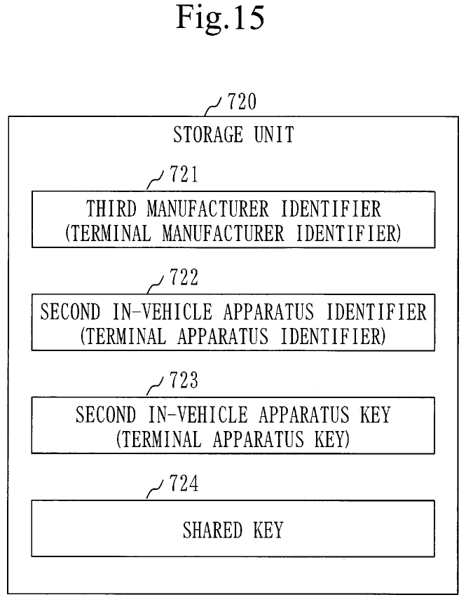

A configuration of the storage unit 720 will be described with referring to FIG. 15.

The storage unit 720 stores data such as a third manufacturer identifier 721, a second in-vehicle apparatus identifier 722, a second in-vehicle apparatus key 723, and a shared key 724. A content of each data will be described alter.

These pieces of data are major data stored in the storage unit 720. The data stored in the storage unit 720 is managed securely so as not leak to the outside.

The third manufacturer identifier 721, the second in-vehicle apparatus identifier 722, the second in-vehicle apparatus key 723, and the shared key 724 are stored in the auxiliary storage device 703 at the time they are received or generated. After that, at the time the second in-vehicle apparatus 700 is started, the third manufacturer identifier 721, the second in-vehicle apparatus identifier 722, the second in-vehicle apparatus key 723, and the shared key 724 are read from the auxiliary storage device 703 and written in the storage unit 720 of the memory 702.

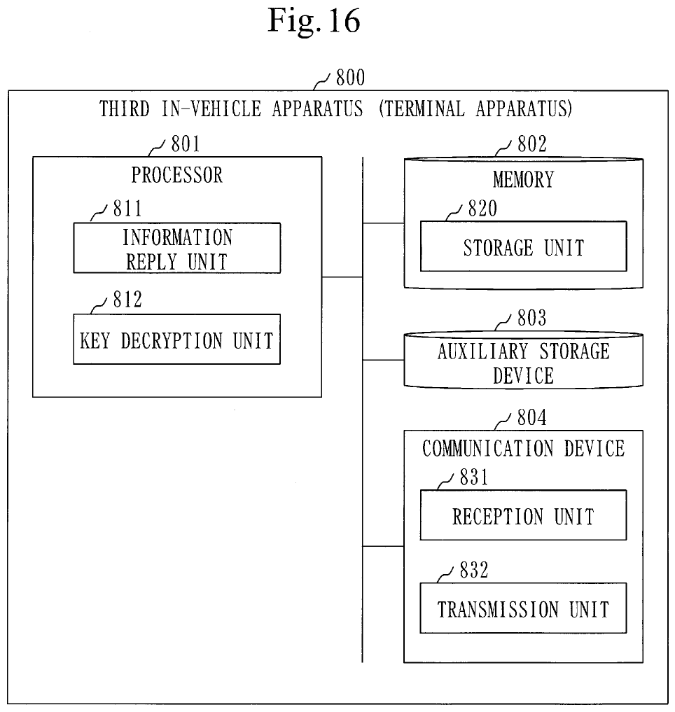

A configuration of the third in-vehicle apparatus 800 will be described with referring to FIG. 16.

The third in-vehicle apparatus 800 is a computer provided with hardware devices such as a processor 801, a memory 802, an auxiliary storage device 803, and a communication device 804. These hardware devices are connected to each other via a signal line.

The processor 801 is a processor provided to the third in-vehicle apparatus 800.

The memory 802 is a memory provided to the third in-vehicle apparatus 800. Data stored in the memory 802 is saved in the auxiliary storage device 803 as necessary.

The auxiliary storage device 803 is an auxiliary storage device provided to the third in-vehicle apparatus 800. Data stored in the auxiliary storage device 803 is loaded to the memory 802 as necessary.

The communication device 804 is a communication device provided to the third in-vehicle apparatus 800.

The third in-vehicle apparatus 800 is provided with elements such as an information reply unit 811 and a key decryption unit 812. These elements are implemented by software.

A third terminal apparatus program to cause the computer to function as the information reply unit 811 and the key decryption unit 812 is stored in the auxiliary storage device 803. The third terminal apparatus program is loaded to the memory 802 and executed by the processor 801.

Furthermore, an OS is stored in the auxiliary storage device 803. At least part of the OS is loaded to the memory 802 and executed by the processor 801.

That is, the processor 801 executes the third terminal apparatus program while executing the OS.

Data obtained by executing the third terminal apparatus program is stored in a storage device such as the memory 802, the auxiliary storage device 803, and a register in the processor 801 or a cache memory in the processor 801.

The memory 802 functions as a storage unit 820 that stores data. Alternatively, another storage device may function as the storage unit 820 in place of the memory 802 or along with the memory 802.

The communication device 804 functions as a reception unit 831 that receives data. Furthermore, the communication device 804 functions as a transmission unit 832 that transmits data.

The third in-vehicle apparatus 800 may be provided with a plurality of processors that replace the processor 801. The plurality of processors share the role of the processor 801.

The third terminal apparatus program can be computer-readably recorded in a non-volatile recording medium such as an optical disk and a flash memory.

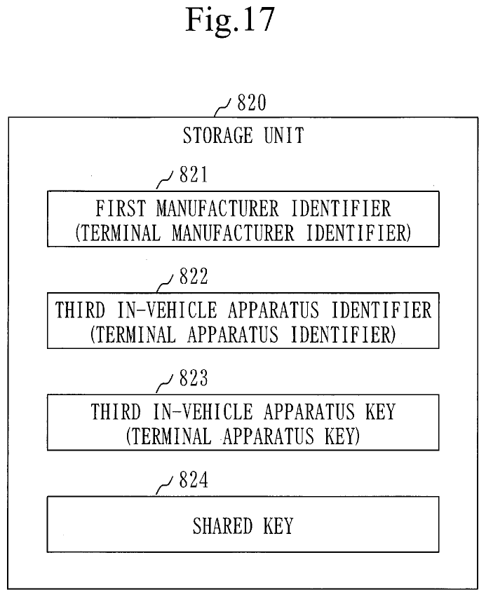

A configuration of the storage unit 820 will be described with referring to FIG. 17.

The storage unit 820 stores data such as a first manufacturer identifier 821, a third in-vehicle apparatus identifier 822, a third in-vehicle apparatus key 823, and a shared key 824. A content of each data will be described later.

These pieces of data are major data stored in the storage unit 820. The data stored in the storage unit 820 is securely managed so as not leak to the outside.

The first manufacturer identifier 821, the third in-vehicle apparatus identifier 822, the third in-vehicle apparatus key 823, and the shared key 824 are stored in the auxiliary storage device 803 at the time they are received or decrypted. After that, at the time the third in-vehicle apparatus 800 is started, the first manufacturer identifier 821, the third in-vehicle apparatus identifier 822, the third in-vehicle apparatus key 823, and the shared key 824 are read from the auxiliary storage device 803 and written in the storage unit 820 of the memory 802.

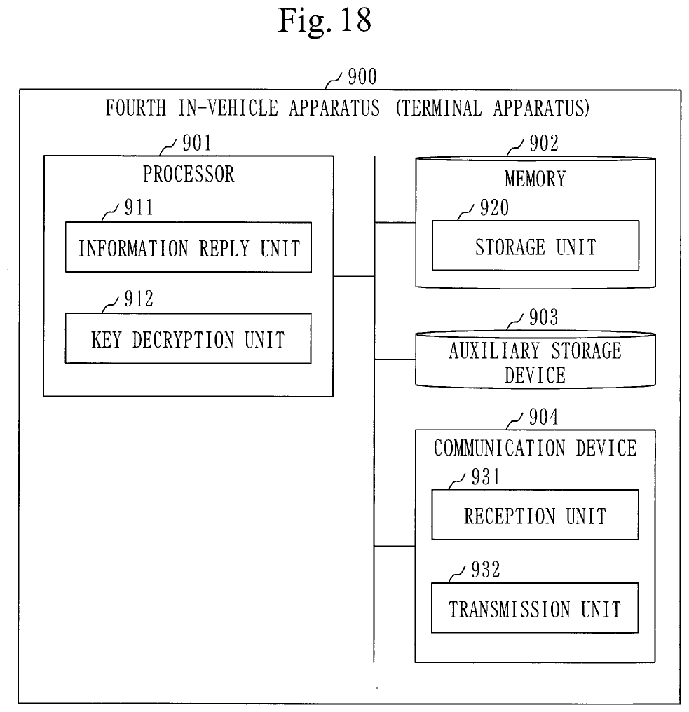

A configuration of the fourth in-vehicle apparatus 900 will be described with referring to FIG. 18.

The fourth in-vehicle apparatus 900 is a computer provided with hardware devices such as a processor 901, a memory 902, an auxiliary storage device 903, and a communication device 904. These hardware devices are connected to each other via a signal line.

The processor 901 is a processor provided to the fourth in-vehicle apparatus 900.

The memory 902 is a memory provided to the fourth in-vehicle apparatus 900. Data stored in the memory 902 is saved in the auxiliary storage device 903 as necessary.

The auxiliary storage device 903 is an auxiliary storage device provided to the fourth in-vehicle apparatus 900. Data stored in the auxiliary storage device 903 is loaded to the memory 902 as necessary.

The communication device 904 is a communication device provided to the fourth in-vehicle apparatus 900.

The fourth in-vehicle apparatus 900 is provided with elements such as an information reply unit 911 and a key decryption unit 912. These elements are implemented by software.

A fourth terminal apparatus program to cause the computer to function as the information reply unit 911 and the key decryption unit 912 is stored in the auxiliary storage device 903. The fourth terminal apparatus program is loaded to the memory 902 and executed by the processor 901.

Furthermore, an OS is stored in the auxiliary storage device 903. At least part of the OS is loaded to the memory 902 and executed by the processor 901.

That is, the processor 901 executes the fourth terminal apparatus program while executing the OS.

Data obtained by executing the fourth terminal apparatus program is stored in a storage device such as the memory 902, the auxiliary storage device 903, and a register in the processor 901 or a cache memory in the processor 901.

The memory 902 functions as a storage unit 920 that stores data. Alternatively, another storage device may function as the storage unit 920 in place of the memory 902 or along with the memory 902.

The communication device 904 functions as a reception unit 931 that receives data. Furthermore, the communication device 904 functions as a transmission unit 932 that transmits data.

The fourth in-vehicle apparatus 900 may be provided with a plurality of processors that replace the processor 901. The plurality of processors share the role of the processor 901.

The fourth terminal apparatus program can be computer-readably recorded in a non-volatile recording medium such as an optical disk and a flash memory.

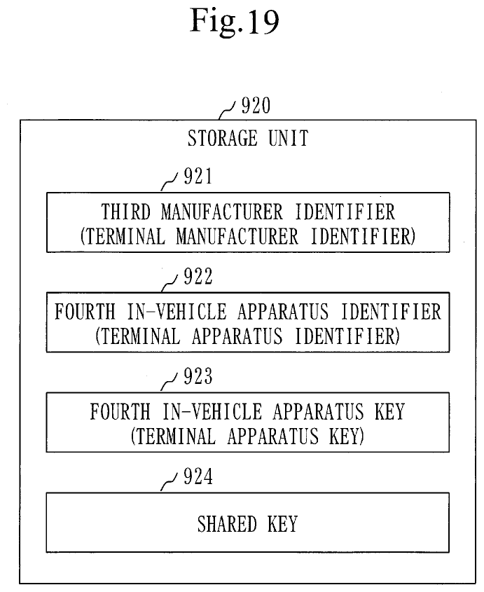

A configuration of the storage unit 920 will be described with referring to FIG. 19.

The storage unit 920 stores data such as a third manufacturer identifier 921, a fourth in-vehicle apparatus identifier 922, a fourth in-vehicle apparatus key 923, and a shared key 924. A content of each data will be described later.

These pieces of data are major data stored in the storage unit 920. The data stored in the storage unit 920 is managed securely so as not leak to the outside.

The third manufacturer identifier 921, the fourth in-vehicle apparatus identifier 922, the fourth in-vehicle apparatus key 923, and the shared key 924 are stored in the auxiliary storage device 903 at the time they are received or decrypted. After that, at the time the fourth in-vehicle apparatus 900 is started, the third manufacturer identifier 921, the fourth in-vehicle apparatus identifier 922, the fourth in-vehicle apparatus key 923, and the shared key 924 are read from the auxiliary storage device 903 and written in the storage unit 920 of the memory 902.

*** Description of Operation ***

An operation of the key sharing system 10 corresponds to a key sharing method. A procedure of the key sharing method corresponds to a procedure of a key sharing program.

An operation of the key management device 100 corresponds to a key management method. A procedure of the key management method corresponds to a procedure of a key management program.

An operation of each apparatus management device (first apparatus management device 200, second apparatus management device 300, or third apparatus management device 400) corresponds to an apparatus management method. A procedure of the apparatus management method corresponds to a procedure of an apparatus management program.

An operation of the gateway 500 corresponds to a communication apparatus control method. A procedure of the communication apparatus control method corresponds to a procedure of a communication apparatus program.

An operation of each in-vehicle apparatus (first in-vehicle apparatus 600, second in-vehicle apparatus 700, third in-vehicle apparatus 800, or fourth in-vehicle apparatus 900) corresponds to a terminal apparatus control method. A procedure of the terminal apparatus control method corresponds to a procedure of a terminal apparatus program.

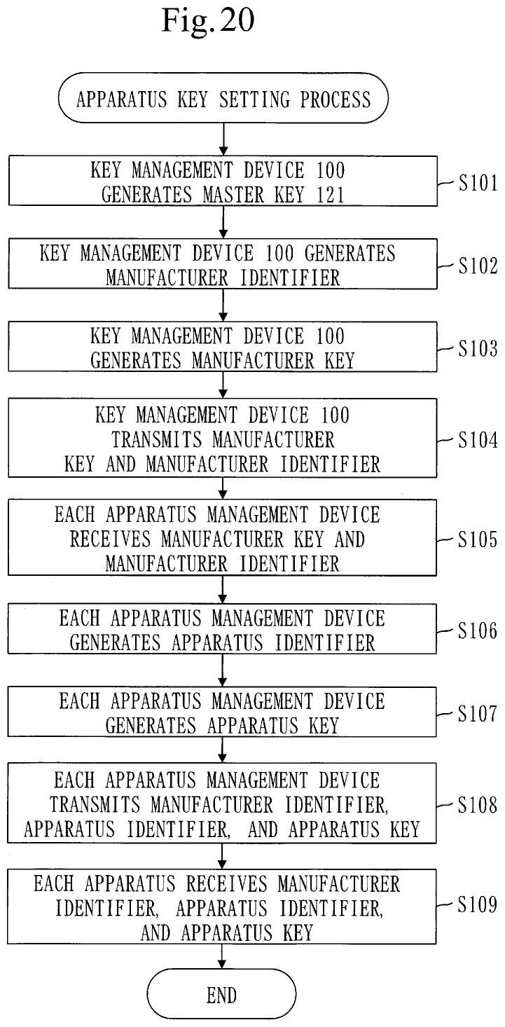

An apparatus key setting process in the key sharing method will be described with referring to FIG. 20.

The apparatus key setting process is a process for setting an apparatus key to each apparatus.

The apparatus key is a key separate for each apparatus and is called an authentication key or apparatus authentication key as well.

An apparatus key of the gateway 500 is called a communication apparatus key.

An apparatus key of each in-vehicle apparatus is called a terminal apparatus key.

Step S101 to step S104 are executed by the key management device 100.

Step S101 is a step of performing a master key generation process.

In step S101, the master key generation unit 111 of the key management device 100 generates the master key 121.

The master key 121 is a key used for generating the first manufacturer key 221, the second manufacturer key 321, and the third manufacturer key 421.

Specifically, the master key generation unit 111 generates a random number. The master key generation unit 111 then takes as input the generated random number and executes a key generation function to generate a key. The generated key is the master key 121.

The key generation function is a function for generating a key. An example of an algorithm for sharing a key is hash-based MAC (HMAC). Note that MAC is an acronym for message authentication code.

Step S102 is a step of performing a manufacturer identifier generation process.

In step S102, the manufacturer key generation unit 112 of the key management device 100 generates the first manufacturer identifier 122, the second manufacturer identifier 123, and the third manufacturer identifier 124.

The first manufacturer identifier 122 is information that identifies the first manufacturer 12.

The second manufacturer identifier 123 is information that identifies the second manufacturer 13.

The third manufacturer identifier 124 is information that identifies the third manufacturer 14.

Specifically, the manufacturer key generation unit 112 generates three character arrays randomly. The generated three character arrays are the first manufacturer identifier 122, the second manufacturer identifier 123, and the third manufacturer identifier 124.

Note that the manufacturer key generation unit 112 may select three manufacturer identifiers from a list including a plurality of manufacturer identifiers as the first manufacturer identifier 122, the second manufacturer identifier 123, and the third manufacturer identifier 124.

The manufacturer key generation unit 112 may generate the first manufacturer identifier 122, the second manufacturer identifier 123, and the third manufacturer identifier 124 in accordance with another method.

Step S103 is a step of performing a manufacturer key generation process.

In step S103, the manufacturer key generation unit 112 of the key management device 100 generates a first manufacturer key using the master key 121 and the first manufacturer identifier 122.

Furthermore, the manufacturer key generation unit 112 generates a second manufacturer key using the master key 121 and the second manufacturer identifier 123.

Furthermore, the manufacturer key generation unit 112 generates a third manufacturer key using the master key 121 and the third manufacturer identifier 124.

The first manufacturer key is an individual key for the first manufacturer 12. The second manufacturer key is an individual key for the second manufacturer 13.

The third manufacturer key is an individual key for the third manufacturer 14. An individual key is a key separate for each manufacturer.

Specifically, the manufacturer key generation unit 112 takes as input the master key 121 and the first manufacturer identifier 122 and executes the key generation function to generate a key. The generated key is the first manufacturer key.

Furthermore, the manufacturer key generation unit 112 takes as input the master key 121 and the second manufacturer identifier 123 and executes the key generation function to generate a key. The generated key is the second manufacturer key.

Furthermore, the manufacturer key generation unit 112 takes as input the master key 121 and the third manufacturer identifier 124 and executes the key generation function to generate a key. The generated key is the third manufacturer key.

Step S104 is a step of performing a transmission process.

In step S104, the transmission unit 132 of the key management device 100 transmits the first manufacturer key and the first manufacturer identifier 122 to the first apparatus management device 200.

Furthermore, the transmission unit 132 transmits the second manufacturer key and the second manufacturer identifier 123 to the second apparatus management device 300.

Furthermore, the transmission unit 132 transmits the third manufacturer key and the third manufacturer identifier 124 to the third apparatus management device 400.

Assume that the first manufacturer key, the first manufacturer identifier 122, the second manufacturer key, the second manufacturer identifier 123, the third manufacturer key, and the third manufacturer identifier 124 are transmitted securely.

Specifically, these keys and identifiers are transmitted using Transport Layer Security (TLS). These keys and identifiers may be distributed off-line securely.

Step S105 to step S108 are executed by each apparatus management device.

Step S105 is a step of performing a reception process and a storage process.

In step S105, the reception unit 231 of the first apparatus management device 200 receives the first manufacturer key and the first manufacturer identifier 122.

The storage unit 220 stores the received first manufacturer key and the received first manufacturer identifier 122.

The first manufacturer key stored in the storage unit 220 is referred to as the first manufacturer key 221. The first manufacturer identifier 122 stored in the storage unit 220 is referred to as the first manufacturer identifier 222.

The reception unit 331 of the second apparatus management device 300 receives the second manufacturer key and the second manufacturer identifier 123. The storage unit 320 stores the received second manufacturer key and the received second manufacturer identifier 123.

The second manufacturer key stored in the storage unit 320 is referred to as the second manufacturer key 321. The second manufacturer identifier 123 stored in the storage unit 320 is referred to as the second manufacturer identifier 322.

The reception unit 431 of the third apparatus management device 400 receives the third manufacturer key and the third manufacturer identifier 124.

The storage unit 420 stores the received third manufacturer key and the received third manufacturer identifier 124.

The third manufacturer key stored in the storage unit 420 is referred to as the third manufacturer key 421. The third manufacturer identifier 124 stored in the storage unit 420 is referred to as the third manufacturer identifier 422.

Step S106 is a step of performing an apparatus identifier generation process.

In step S106, the apparatus key generation unit 211 of the first apparatus management device 200 generates the gateway identifier 223 and the third in-vehicle apparatus identifier 224.

The gateway identifier 223 is an apparatus identifier for the gateway 500 and identifies the gateway 500.

The third in-vehicle apparatus identifier 224 is an apparatus identifier for the third in-vehicle apparatus 800 and identifies the third in-vehicle apparatus 800.

Specifically, the apparatus key generation unit 211 generates two character arrays randomly. The generated two character arrays are the gateway identifier 223 and the third in-vehicle apparatus identifier 224.

Note that the apparatus key generation unit 211 may select the two apparatus identifiers from a list including a plurality of apparatus identifiers, as the gateway identifier 223 and the third in-vehicle apparatus identifier 224.

The apparatus key generation unit 211 may generate the gateway identifier 223 and the third in-vehicle apparatus identifier 224 in accordance with another method.

The apparatus key generation unit 311 of the second apparatus management device 300 generates the first in-vehicle apparatus identifier 323.

The first in-vehicle apparatus identifier 323 is an apparatus identifier for the first in-vehicle apparatus 600 and identifies the first in-vehicle apparatus 600.

A method of generating the first in-vehicle apparatus identifier 323 is the same as the method of generating the gateway identifier 223 or the third in-vehicle apparatus identifier 224.

The apparatus key generation unit 411 of the third apparatus management device 400 generates the second in-vehicle apparatus identifier 423 and the fourth in-vehicle apparatus identifier 424.

The second in-vehicle apparatus identifier 423 is an apparatus identifier for the second in-vehicle apparatus 700 and identifies the second in-vehicle apparatus 700.

The fourth in-vehicle apparatus identifier 424 is an apparatus identifier for the fourth in-vehicle apparatus 900 and identifies the fourth in-vehicle apparatus 900.

A method of generating the second in-vehicle apparatus identifier 423 and the fourth in-vehicle apparatus identifier 424 is the same as the method of generating the gateway identifier 223 and the third in-vehicle apparatus identifier 224.

Step S107 is a step of performing an apparatus key generation process.

In step S107, the apparatus key generation unit 211 of the first apparatus management device 200 generates a gateway key using the first manufacturer key 221 and the gateway identifier 223.

Furthermore, the apparatus key generation unit 211 generates a third in-vehicle apparatus key using the first manufacturer key 221 and the third in-vehicle apparatus identifier 224.

The gateway key is an apparatus key for the gateway 500.

The third in-vehicle apparatus key is an apparatus key for the third in-vehicle apparatus 800.

Specifically, the apparatus key generation unit 211 takes as input the first manufacturer key 221 and the gateway identifier 223 and executes the key generation function to generate a key. The generated key is the gateway key.

Furthermore, the apparatus key generation unit 211 takes as input the first manufacturer key 221 and the third in-vehicle apparatus identifier 224 and executes the key generation function to generate a key. The generated key is the third in-vehicle apparatus key.

The apparatus key generation unit 311 of the second apparatus management device 300 generates a first in-vehicle apparatus key using the second manufacturer key 321 and the first in-vehicle apparatus identifier 323.

The first in-vehicle apparatus key is an apparatus key for the first in-vehicle apparatus 600.

Specifically, the apparatus key generation unit 311 takes as input the second manufacturer key 321 and the first in-vehicle apparatus identifier 323 and executes the key generation function to generate a key. The generated key is the first in-vehicle apparatus key.

The apparatus key generation unit 411 of the third apparatus management device 400 generates a second in-vehicle apparatus key using the third manufacturer key 421 and the second in-vehicle apparatus identifier 423.

Furthermore, the apparatus key generation unit 411 generates a fourth in-vehicle apparatus key using the third manufacturer key 421 and the fourth in-vehicle apparatus identifier 424.

The second in-vehicle apparatus key is an apparatus key for the second in-vehicle apparatus 700.

The fourth in-vehicle apparatus key is an apparatus key for the fourth in-vehicle apparatus 900.

Specifically, the apparatus key generation unit 411 takes as input the third manufacturer key 421 and the second in-vehicle apparatus identifier 423 and executes the key generation function to generate a key. The generated key is the second in-vehicle apparatus key.

Furthermore, the apparatus key generation unit 411 takes as input the third manufacturer key 421 and the fourth in-vehicle apparatus identifier 424 and executes the key generation function to generate a key. The generated key is the fourth in-vehicle apparatus key.

Step S108 is a step of performing a transmission process.

In step S108, the transmission unit 232 of the first apparatus management device 200 transmits the first manufacturer identifier 222, the gateway identifier 223, and the gateway key to the gateway 500.

Furthermore, the transmission unit 232 transmits the first manufacturer identifier 222, the third in-vehicle apparatus identifier 224, and the third in-vehicle apparatus key to the third in-vehicle apparatus 800.

The transmission unit 332 of the second apparatus management device 300 transmits the second manufacturer identifier 322, the first in-vehicle apparatus identifier 323, and the first in-vehicle apparatus key to the first in-vehicle apparatus 600.

The transmission unit 432 of the third apparatus management device 400 transmits the third manufacturer identifier 422, the second in-vehicle apparatus identifier 423, and the second in-vehicle apparatus key to the second in-vehicle apparatus 700.

Furthermore, the transmission unit 432 transmits the third manufacturer identifier 422, the fourth in-vehicle apparatus identifier 424, and the fourth in-vehicle apparatus key to the fourth in-vehicle apparatus 900.

Step S109 is executed by each apparatus.

Step S109 is a step of performing a reception process and a storage process.

In step S109, the reception unit 531 of the gateway 500 receives the first manufacturer identifier 222, the gateway identifier 223, and the gateway key.

The storage unit 520 stores the received first manufacturer identifier 222, the received gateway identifier 223, and the received gateway key.

The first manufacturer identifier 222 stored in the storage unit 520 is referred to as the first manufacturer identifier 521. The gateway identifier 223 stored in the storage unit 520 is referred to as the gateway identifier 522. The gateway key stored in the storage unit 520 is referred to as the gateway key 523.

The first manufacturer identifier 521 is a communication manufacturer identifier. A manufacturer key corresponding to the communication manufacturer identifier is referred to as a communication manufacturer key.

The gateway identifier 522 is a communication apparatus identifier.

The gateway key 523 is a communication apparatus key.

The reception unit 631 of the first in-vehicle apparatus 600 receives the second manufacturer identifier 322, the first in-vehicle apparatus identifier 323, and the first in-vehicle apparatus key.

The storage unit 620 stores the received second manufacturer identifier 322, the received first in-vehicle apparatus identifier 323, and the received first in-vehicle apparatus key.

The second manufacturer identifier 322 stored in the storage unit 620 is referred to as the second manufacturer identifier 621. The first in-vehicle apparatus identifier 323 stored in the storage unit 620 is referred to as the first in-vehicle apparatus identifier 622. The first in-vehicle apparatus key stored in the storage unit 620 is referred to as the first in-vehicle apparatus key 623.

The second manufacturer identifier 621 is a terminal manufacturer identifier. A manufacturer key corresponding to the terminal manufacturer identifier is referred to as a terminal manufacturer key.

The first in-vehicle apparatus identifier 622 is a terminal apparatus identifier.

The first in-vehicle apparatus key 623 is a terminal apparatus key.

The reception unit 731 of the second in-vehicle apparatus 700 receives the third manufacturer identifier 422, the second in-vehicle apparatus identifier 423, and the second in-vehicle apparatus key.

The storage unit 720 stores the received third manufacturer identifier 422, the received second in-vehicle apparatus identifier 423, and the received second in-vehicle apparatus key.

The third manufacturer identifier 422 stored in the storage unit 720 is referred to as the third manufacturer identifier 721. The second in-vehicle apparatus identifier 423 stored in the storage unit 720 is referred to as the second in-vehicle apparatus identifier 722. The second in-vehicle apparatus key stored in the storage unit 720 is referred to as the second in-vehicle apparatus key 723.

The third manufacturer identifier 721 is a terminal manufacturer identifier.

The second in-vehicle apparatus identifier 722 is a terminal apparatus identifier.

The second in-vehicle apparatus key 723 is a terminal apparatus key.

The reception unit 831 of the third in-vehicle apparatus 800 receives the first manufacturer identifier 222, the third in-vehicle apparatus identifier 224, and the third in-vehicle apparatus key.

The storage unit 820 stores the received first manufacturer identifier 222, the received third in-vehicle apparatus identifier 224, and the received third in-vehicle apparatus key.

The first manufacturer identifier 222 stored in the storage unit 820 is referred to as the first manufacturer identifier 821. The third in-vehicle apparatus identifier 224 stored in the storage unit 820 is referred to as the third in-vehicle apparatus identifier 822. The third in-vehicle apparatus key stored in the storage unit 820 is referred to as the third in-vehicle apparatus key 823.

The first manufacturer identifier 821 is a terminal manufacturer identifier.

The third in-vehicle apparatus identifier 822 is a terminal apparatus identifier.

The third in-vehicle apparatus key 823 is a terminal apparatus key.

The reception unit 931 of the fourth in-vehicle apparatus 900 receives the third manufacturer identifier 422, the fourth in-vehicle apparatus identifier 424, and the fourth in-vehicle apparatus key.

The storage unit 920 stores the received third manufacturer identifier 422, the received fourth in-vehicle apparatus identifier 424, and the received fourth in-vehicle apparatus key.

The third manufacturer identifier 422 stored in the storage unit 920 is referred to as the third manufacturer identifier 921. The fourth in-vehicle apparatus identifier 424 stored in the storage unit 920 is referred to as the fourth in-vehicle apparatus identifier 922. The fourth in-vehicle apparatus key stored in the storage unit 920 is referred to as the fourth in-vehicle apparatus key 923.

The third manufacturer identifier 921 is a terminal manufacturer identifier.

The fourth in-vehicle apparatus identifier 922 is a terminal apparatus identifier. The fourth in-vehicle apparatus key 923 is a terminal apparatus key.

By the above apparatus key setting process (see FIG. 4), an apparatus key is set in each apparatus.

Processes of step S101 to step S105 are performed once at a stage before each apparatus is manufactured at a factory of each manufacturer.

Processes of step S106 to step S109 are performed at a stage before the vehicle 15 is manufactured by the business operator 11. For example, the processes of step S106 to step S109 are performed at a stage where the gateway 500 or the third in-vehicle apparatus 800 is manufactured at a factory of the first manufacturer 12.

The business operator 11 purchases apparatuses from the manufacturers and manufactures the vehicle 15 at a factory. At the time of purchase, an apparatus key has been set in each apparatus.

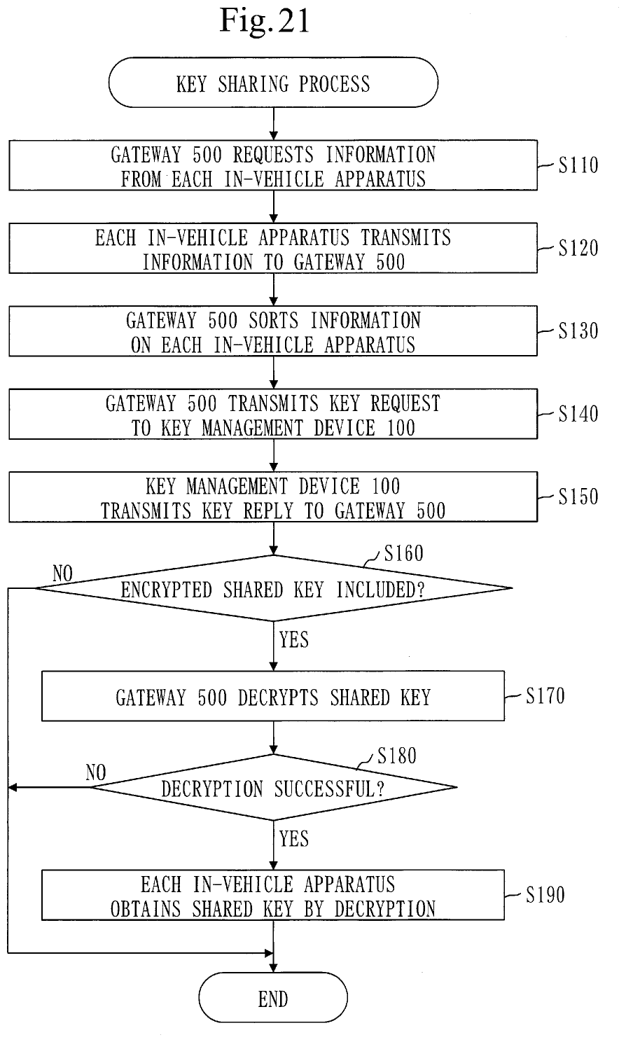

A key sharing process in the key sharing method will be described with referring to FIG. 21.

The key sharing process is a process for the gateway 500 to share a key with each in-vehicle apparatus.

The key which the gateway 500 shares with each in-vehicle apparatus is referred to as a shared key. The shared key is also referred to as an authentication key.

Step S110 is a step of performing an information request process.

In step S110, the gateway 500 requests information from each in-vehicle apparatus.

The information request process (S110) will be described later in detail.

Step S120 is a step of performing an information transmission process.

In step S120, each in-vehicle apparatus transmits information to the gateway 500.

The information transmission process (S120) will be described later in detail.

Step S130 is a step of performing an information reception process and a sort process.

In step S130, the information request unit 511 of the gateway 500 receives information from each in-vehicle apparatus via the reception unit 531.

After information is received from each of all the in-vehicle apparatuses, the information sort unit 512 of the gateway 500 sorts the information on each in-vehicle apparatus.

Information sort signifies to arrange information in accordance with an arrangement order rule. The arrangement order rule is a rule that determines an arrangement order.

Data in which the information on the gateway 500 and the information on the in-vehicle apparatus are set is referred to as sort information data.

The sort process (S130) will be described later in detail.

Step S140 is a step of performing a key request process.

In step S140, the gateway 500 transmits a key request including the sort information data to the key management device 100.

Specifically, the key request unit 513 of the gateway 500 generates the key request including the sort information data and transmits the generated key request to the key management device 100 via the transmission unit 532.

Step S150 is a process of performing a key reply process.

In step S150, the key management device 100 performs verification on each in-vehicle apparatus and transmits a key reply including an encrypted shared key of the gateway 500 and encrypted shared keys of right in-vehicle apparatuses to the gateway 500.

An encrypted shared key is a shared key that is encrypted.

The key reply process (S150) will be described later in detail.

Step S160 is a step of performing a key reception process and a determination process.

In step S160, the information request unit 511 of the gateway 500 receives the key reply from the key management device 100 via the reception unit 531.

Then, the key decryption unit 514 of the gateway 500 determines whether the encrypted shared key of each of all the in-vehicle apparatuses is included in the key reply.

If the encrypted shared key of each of all the in-vehicle apparatuses is included in the key reply, the processing proceeds to step S170.

If an encrypted shared key of at least one in-vehicle apparatus is not included in the key reply, the gateway 500 does not share keys with the in-vehicle apparatuses, and the processing ends.

Step S170 is a step of performing a key decryption process.

In step S170, the key decryption unit 514 of the gateway 500 decrypts the encrypted shared key for the gateway 500 into a shared key using the gateway key 523.

When the decryption is successful, a shared key is obtained.

Specifically, the key decryption unit 514 decrypts the encrypted shared key for the gateway 500 into the shared key by authentication cryptography using the gateway key 523. More specifically, the key decryption unit 514 takes as input the gateway key 523 and the encrypted shared key for the gateway 500 and executes a decryption function of the authentication cryptography.

In decryption according to authentication cryptography, authentication and decryption are performed. When the authentication is successful, decryption is successful. When the authentication fails, the decryption fails.

Step S180 is a step of performing a determination process.

In step S180, the key distribution unit 515 of the gateway 500 determines whether the encrypted shared key of the gateway 500 is successfully decrypted into a shared key. That is, the key distribution unit 515 determines whether the decryption is successful.

If the decryption is successful, the storage unit 520 stores the shared key obtained by decryption. The shared key to be stored is the shared key 524. After that, the processing proceeds to step S190.

If the decryption fails, the key distribution unit 515 performs an error process. After that, the processing ends. In this case, the gateway 500 cannot share a shared key with each in-vehicle apparatus.

Step S190 is a step of performing a key decryption process.

In step S190, the gateway 500 transmits the encrypted shared key to each in-vehicle apparatus.

Each in-vehicle apparatus receives the encrypted shared key and decrypts the encrypted shared key into a shared key.

The key decryption process (S190) will be described later in detail.

The information request process (S110), the information transmission process (S120), the sort process (S130), the key reply process (S150), and the key decryption process (S190) will now be described in detail.

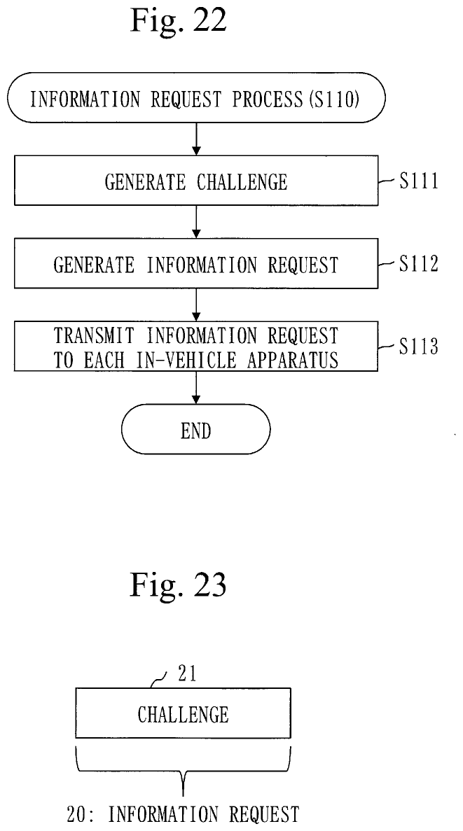

The information request process (S110) will be described in detail with referring to FIG. 22.

The information request process (S110) is a process for the gateway 500 to request information from each in-vehicle apparatus.

In step S111, the information request unit 511 generates a challenge of challenge response authentication.

Specifically, the information request unit 511 generates a random number. The generated random number is the challenge.

In step S112, the information request unit 511 generates an information request including the challenge.

In step S113, the information request unit 511 transmits the information request to each in-vehicle apparatus via the transmission unit 532.

FIG. 23 illustrates an information request 20.

The information request 20 includes a challenge 21.

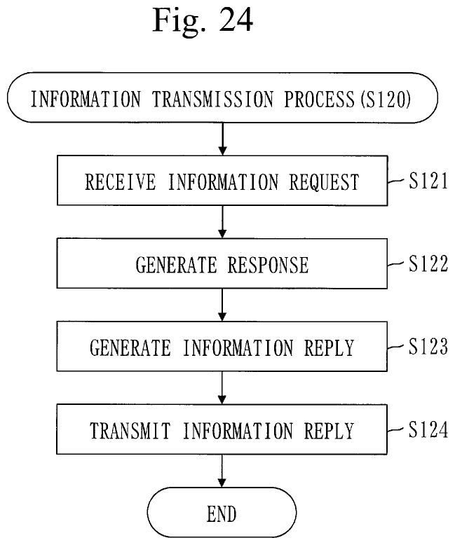

The information transmission process (S120) will be described in detail with referring to FIG. 24.

The information transmission process (S120) is a process for each in-vehicle apparatus to transmit information to the gateway 500.

In step S121, each in-vehicle apparatus receives the information request from the gateway 500.

That is, the information reply unit 611 of the first in-vehicle apparatus 600 receives the information request 20 from the gateway 500 via the reception unit 631.

The information reply unit 711 of the second in-vehicle apparatus 700 receives the information request 20 from the gateway 500 via the reception unit 731.

The information reply unit 811 of the third in-vehicle apparatus 800 receives the information request 20 from the gateway 500 via the reception unit 831.

The information reply unit 911 of the fourth in-vehicle apparatus 900 receives the information request 20 from the gateway 500 via the reception unit 931.

In step S122, each in-vehicle apparatus acquires the challenge from the received information request and generates a response corresponding to the challenge and apparatus key.

Specifically, each in-vehicle apparatus encrypts the challenge in accordance with a cryptographic algorithm using the apparatus key. The encrypted challenge is the response.

For example, the cryptographic algorithm is Advanced Encryption Standard (AES).

That is, the information reply unit 611 of the first in-vehicle apparatus 600 acquires the challenge 21 from the received information request 20 and generates a response 31 using the challenge 21 and the first in-vehicle apparatus key 623.

The information reply unit 711 of the second in-vehicle apparatus 700 acquires the challenge 21 from the received information request 20 and generates a response 41 using the challenge 21 and the second in-vehicle apparatus key 723.

The information reply unit 811 of the third in-vehicle apparatus 800 acquires the challenge 21 from the received information request 20 and generates a response 51 using the challenge 21 and the third in-vehicle apparatus key 823.

The information reply unit 911 of the fourth in-vehicle apparatus 900 acquires the challenge 21 from the received information request 20 and generates a response 61 using the challenge 21 and the fourth in-vehicle apparatus key 923.

A method of generating each one of the response 31, the response 41, the response 51, and response 61 has been described earlier.

In step S123, each in-vehicle apparatus generates an information reply including information on the in-vehicle apparatus. The information on the in-vehicle apparatus includes a manufacturer identifier, an apparatus identifier, and a response.

That is, the information reply unit 611 of the first in-vehicle apparatus 600 generates an information reply 30 including information on the first in-vehicle apparatus 600. The information on the first in-vehicle apparatus 600 includes the second manufacturer identifier 621, the first in-vehicle apparatus identifier 622, and the response 31.

The information reply unit 711 of the second in-vehicle apparatus 700 generates an information reply 40 including information on the second in-vehicle apparatus 700. The information on the second in-vehicle apparatus 700 includes the third manufacturer identifier 721, the second in-vehicle apparatus identifier 722, and the response 41.

The information reply unit 811 of the third in-vehicle apparatus 800 generates an information reply 50 including information on the third in-vehicle apparatus 800. The information on the third in-vehicle apparatus 800 includes the first manufacturer identifier 821, the third in-vehicle apparatus identifier 822, and the response 51.

The information reply unit 911 of the fourth in-vehicle apparatus 900 generates an information reply 60 including information on the fourth in-vehicle apparatus 900. The information on the fourth in-vehicle apparatus 900 includes the third manufacturer identifier 921, the fourth in-vehicle apparatus identifier 922, and the response 61.

In step S124, each in-vehicle apparatus transmits the information reply to the gateway 500.

That is, the information reply unit 611 of the first in-vehicle apparatus 600 transmits the information reply 30 to the gateway 500 via the transmission unit 632.

The information reply unit 711 of the second in-vehicle apparatus 700 transmits the information reply 40 to the gateway 500 via the transmission unit 732.

The information reply unit 811 of the third in-vehicle apparatus 800 transmits the information reply 50 to the gateway 500 via the transmission unit 832.

The information reply unit 911 of the fourth in-vehicle apparatus 900 transmits the information reply 60 to the gateway 500 via the transmission unit 932.

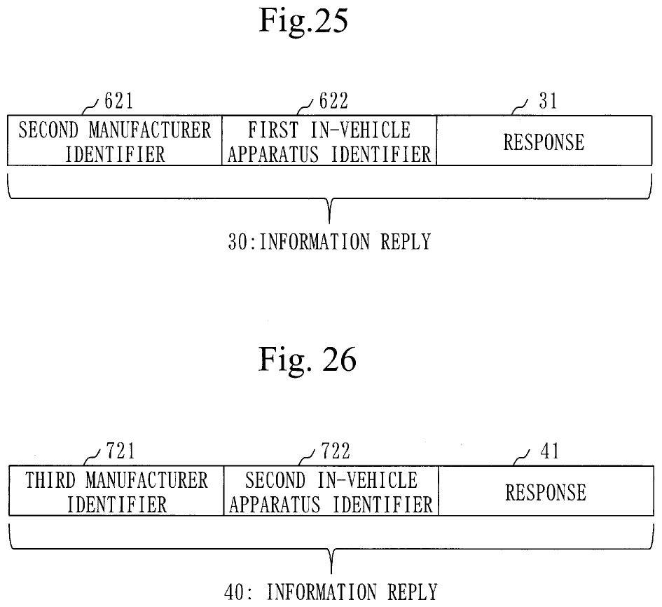

FIG. 25 illustrates the information reply 30.

The information reply 30 includes the second manufacturer identifier 621, the first in-vehicle apparatus identifier 622, and the response 31 which are the information on the first in-vehicle apparatus 600.

FIG. 26 illustrates the information reply 40.

The information reply 40 includes the third manufacturer identifier 721, second in-vehicle apparatus identifier 722, and response 41 which are the information on the second in-vehicle apparatus 700.

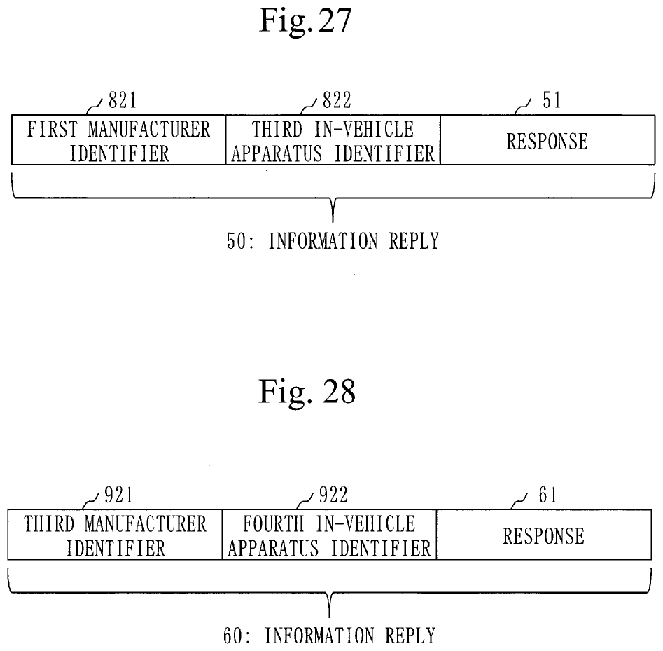

FIG. 27 illustrates the information reply 50.

The information reply 50 includes the first manufacturer identifier 821, third in-vehicle apparatus identifier 822, and response 51 which are the information on the third in-vehicle apparatus 800.

FIG. 28 illustrates the information reply 60.

The information reply 60 includes the third manufacturer identifier 921, fourth in-vehicle apparatus identifier 922, and response 61 which are the information on the fourth in-vehicle apparatus 900.

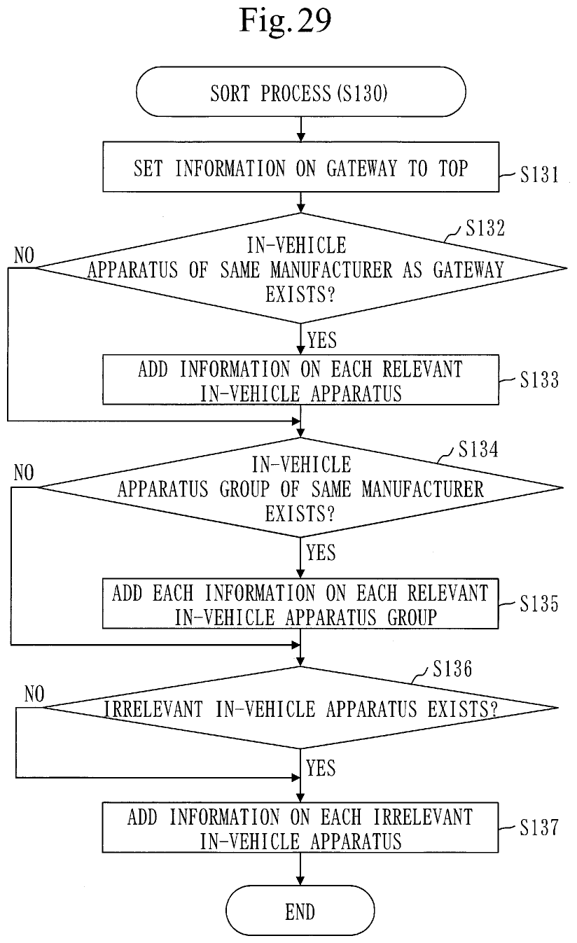

The sort process (S130) will be described in detail with referring to FIG. 29.

The sort process (S130) is a process for sorting information on each in-vehicle apparatus.

In step S131, the information sort unit 512 sets information on the gateway 500 to the top of the sort information data.

Specifically, the information on the gateway 500 includes the first manufacturer identifier 521, the gateway identifier 522, and the challenge 21.

In step S132, the information sort unit 512 refers to the information on each in-vehicle apparatus and determines whether an in-vehicle apparatus of the same manufacturer as the gateway 500 exists.

An in-vehicle apparatus of the same manufacturer as the gateway 500 is referred to as a relevant in-vehicle apparatus.

The information reply 50 of FIG. 27 includes the first manufacturer identifier 821 which is part of the information on the third in-vehicle apparatus 800. The first manufacturer identifier 821 coincides with the first manufacturer identifier 521. Hence, the third in-vehicle apparatus 800 is a relevant in-vehicle apparatus.

If a relevant in-vehicle apparatus exists, the processing advances to step S133. If a relevant in-vehicle apparatus does not exist, the processing advances to step S134.

In step S133, the information sort unit 512 adds information on each relevant in-vehicle apparatus to the sort information data.

The first manufacturer identifier 521 has been set in the sort information data as part of the information on the gateway 500. Therefore, the information sort unit 512 removes the manufacturer identifier from the information on each relevant in-vehicle apparatus, and adds resultant information on each relevant in-vehicle apparatus to the sort information data.

Hence, the information sort unit 512 removes the first manufacturer identifier 821 from the information on the third in-vehicle apparatus 800, and adds the resultant information on the third in-vehicle apparatus 800 to the sort information data.

In step S134, the information sort unit 512 refers to the information on each in-vehicle apparatus and determines whether an in-vehicle apparatus group exists that consists of two or more in-vehicle apparatuses of manufacturers that are different from the manufacturer of the gateway 500 but are the same with each other.

An in-vehicle apparatus group consisting of two or more in-vehicle apparatuses of manufacturers that are different from the manufacturer of the gateway 500 but are the same with each other is referred to as a relevant in-vehicle apparatus group.

The information reply 40 of FIG. 26 includes the third manufacturer identifier 721 which is part of the information on the second in-vehicle apparatus 700. The information reply 60 of FIG. 28 includes the third manufacturer identifier 921 which is part of the information on the fourth in-vehicle apparatus 900. The third manufacturer identifier 721 coincides with the third manufacturer identifier 921. Hence, the second in-vehicle apparatus 700 and the fourth in-vehicle apparatus 900 make up a relevant in-vehicle apparatus group.

If a relevant in-vehicle apparatus exists, the processing advances to step S135.

If a relevant in-vehicle apparatus group does not exist, the processing advances to step S136.

In step S135, the information sort unit 512 adds each information on a relevant in-vehicle apparatus group to the sort information data for each relevant in-vehicle apparatus group.

Note that the manufacturer identifiers are the same in the relevant in-vehicle apparatus group. The information sort unit 512 adds top information among pieces of information on the relevant in-vehicle apparatus group to the sort information data. Furthermore, the information sort unit 512 removes a manufacturer identifier from the second information and each subsequent information of information on the relevant in-vehicle apparatus group, and adds the resultant second information and each subsequent information to the sort information data.

Hence, the information sort unit 512 adds the information on the second in-vehicle apparatus 700 to the sort information data. Furthermore, the information sort unit 512 removes the third manufacturer identifier 921 from the information on the fourth in-vehicle apparatus 900, and adds the resultant information on the fourth in-vehicle apparatus 900 to the sort information data.

In step S136, the information sort unit 512 refers to the information on each in-vehicle apparatus and determines whether an in-vehicle apparatus exists that is of a manufacturer different from the manufacturer of the gateway 500 and the manufacturers of each relevant in-vehicle apparatus group.

An in-vehicle apparatus of a manufacturer different from the manufacturer of the gateway 500 and any one manufacturer of each relevant in-vehicle apparatus group is referred to as an irrelevant in-vehicle apparatus.

The information reply 30 of FIG. 25 includes the second manufacturer identifier 621 which is part of the information on the first in-vehicle apparatus 600. The second manufacturer identifier 621 coincides with none of the first manufacturer identifier 521, the third manufacturer identifier 721, the first manufacturer identifier 821, and the third manufacturer identifier 921. Hence, the first in-vehicle apparatus 600 is an irrelevant in-vehicle apparatus.

If an irrelevant in-vehicle apparatus exists, the processing proceeds to step S137.

If an irrelevant in-vehicle apparatus does not exists, the processing ends.

In step S137, the information sort unit 512 adds information on each irrelevant in-vehicle apparatus to the sort information data.

Hence, the information sort unit 512 adds the information on the first in-vehicle apparatus 600 to the sort information data.

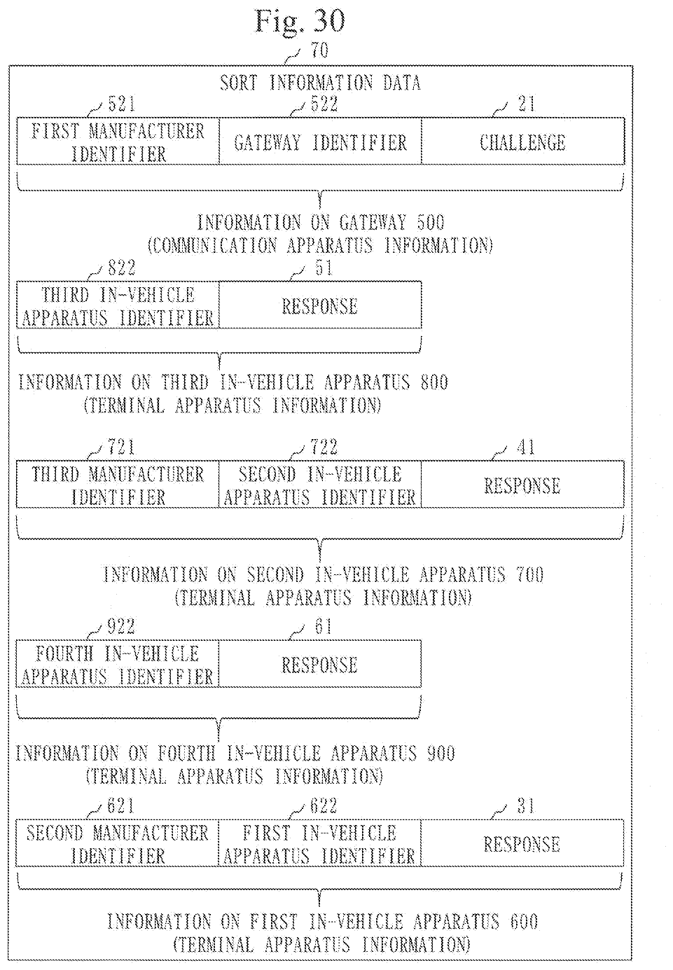

Sort information data 70 will be described with referring to FIG. 30.

The sort information data 70 includes the information on the gateway 500 and information on each in-vehicle apparatus. Each information is arranged as follows.

The top information is the information on the gateway 500. The information on the gateway 500 includes the first manufacturer identifier 521, the gateway identifier 522, and the challenge 21. The manufacturer of the gateway 500 is the first manufacturer 12.

The second information is the information on the third in-vehicle apparatus 800. The information on the third in-vehicle apparatus 800 includes the third in-vehicle apparatus identifier 822 and the response 51. The manufacturer of the third in-vehicle apparatus 800 is the first manufacturer 12, and accordingly the third in-vehicle apparatus 800 is of the same manufacturer as the manufacturer of the gateway 500. Hence, the information on the third in-vehicle apparatus 800 does not include the first manufacturer identifier 821.

The third information is the information on the second in-vehicle apparatus 700. The information on the second in-vehicle apparatus 700 includes the third manufacturer identifier 721, the second in-vehicle apparatus identifier 722, and the response 41. The manufacturer of the second in-vehicle apparatus 700 is the third manufacturer 14, and accordingly the second in-vehicle apparatus 700 is of a manufacturer different from the manufacturer of the gateway 500.

The fourth information is the information on the fourth in-vehicle apparatus 900. The information on the fourth in-vehicle apparatus 900 includes the fourth in-vehicle apparatus identifier 922 and the response 61. The manufacturer of the fourth in-vehicle apparatus 900 is the third manufacturer 14, and accordingly the fourth in-vehicle apparatus 900 is of the same manufacturer as the second in-vehicle apparatus 700. Hence, the information on the fourth in-vehicle apparatus 900 does not include the third manufacturer identifier 921.

The last information is the information on the first in-vehicle apparatus 600. The information on the first in-vehicle apparatus 600 includes the second manufacturer identifier 621, the first in-vehicle apparatus identifier 622, and the response 31. The manufacturer of the first in-vehicle apparatus 600 is the second manufacturer 13. Accordingly, the first in-vehicle apparatus 600 is of a manufacturer different from the manufacturer of the gateway 500 and the manufacturer of any other in-vehicle apparatus.

The information, included in the sort information data 70, on the gateway 500 is referred to as communication apparatus information.

Information, included in the sort information data 70, on each in-vehicle apparatus is referred to as terminal apparatus information.

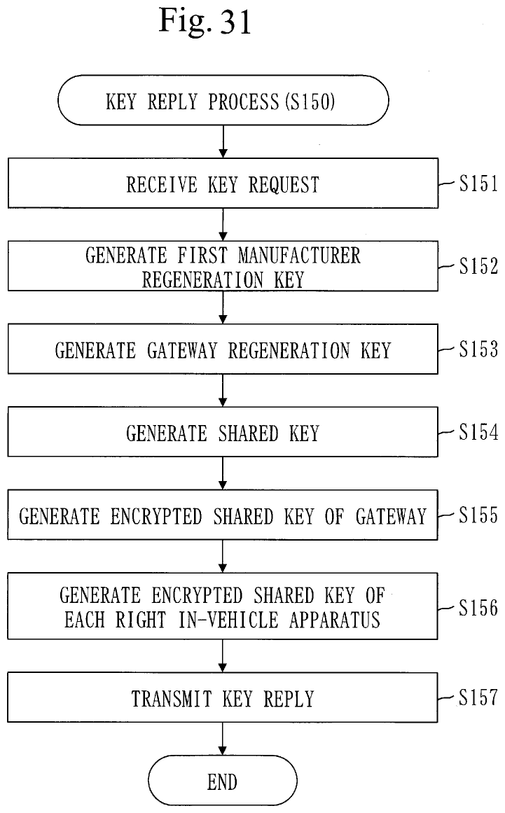

The key reply process (S150) will be described in detail with referring to FIG. 31.

The key reply process (S150) is a process for transmitting the encrypted shared key of the gateway 500 and an encrypted shared key of each right in-vehicle apparatus to the gateway 500 from the key management device 100.

Step S151 is a step of performing a request reception process.

In step S151, the reception unit 131 of the key management device 100 receives the key request.

The key request includes the sort information data.

Step S152 is a first manufacturer key regeneration process.

In step S152, the manufacturer key generation unit 112 of the key management device 100 acquires the top information, that is, the information on the gateway 500, from the sort information data.

The manufacturer key generation unit 112 acquires the first manufacturer identifier 521 from the information on the gateway 500.

The manufacturer key generation unit 112 then generates a first manufacturer key using the master key 121 and the first manufacturer identifier 521. The generated first manufacturer key is referred to as a first manufacturer regeneration key.

A method of generating the first manufacturer regeneration key is the same as the method of generating the first manufacturer key of step S103.

The first manufacturer regeneration key corresponds to the first manufacturer key generated in step S103. Therefore, when the first manufacturer identifier 521 is correct, that is, when the first manufacturer identifier 521 coincides with the first manufacturer identifier 122 stored in the storage unit 120, the first manufacturer regeneration key coincides with the first manufacturer key generated in step S103.

Step S153 is a gateway regeneration process.

In step S153, the apparatus key generation unit 113 of the key management device 100 acquires the gateway identifier 522 from the information on the gateway 500.

The apparatus key generation unit 113 then generates a gateway key using the first manufacturer regeneration key and the gateway identifier 522. The generated gateway key is referred to as a gateway regeneration key.

A method of generating the gateway regeneration key is the same as the method of generating the gateway key in step S107.

The gateway regeneration key corresponds to the gateway key 523 generated in step S107 and stored in the storage unit 520 of the gateway 500 in step S109. Therefore, when the first manufacturer regeneration key and the gateway identifier 522 are correct, the gateway regeneration key coincides with the gateway key 523. When the first manufacturer regeneration key is correct is when the first manufacturer regeneration key coincides with the first manufacturer key generated in step S103. When the gateway identifier 522 is correct is when the gateway identifier 522 coincides with the gateway identifier 223 generated in step S106.

Step S154 is a shared key generation process.

In step S154, the shared key generation unit 115 of the key management device 100 generates a shared key.

Specifically, the shared key generation unit 115 generates a random number. The shared key generation unit 115 takes as input the generated random number and executes the key generation function to generate a key. The generated key is the shared key.

Step S155 is an encrypted shared key generation process.

In step S155, the shared key encryption unit 116 of the key management device 100 encrypts the shared key using the gateway regeneration key. As a result, an encrypted shared key of the gateway 500 is generated.

Specifically, the shared key encryption unit 116 encrypts the shared key by authentication cryptography using the gateway regeneration key. More specifically, the shared key encryption unit 116 takes as input the gateway regeneration key and the shared key and executes an encryption function based on the authentication cryptography to encrypt the shared key by the authentication cryptography. The shared key that is encrypted is the encrypted shared key of the gateway 500. The encryption function is a function for encrypting data.

Step S156 involves an in-vehicle apparatus verification process and an encrypted shared key generation process.

In step S156, the verification unit 114 of the key management device 100 verifies each in-vehicle apparatus and generates an encrypted shared key of each right in-vehicle apparatus.

The in-vehicle apparatus verification process and the encrypted shared key generation process (S156) will be described later in detail.

Step S157 is a request transmission process.

In step S157, the shared key reply unit 117 of the key management device 100 generates a key reply including the encrypted shared key of the gateway 500 and the encrypted shared key of each right in-vehicle apparatus.

The shared key reply unit 117 then transmits an encrypted shared key reply to the gateway 500 via the transmission unit 132.

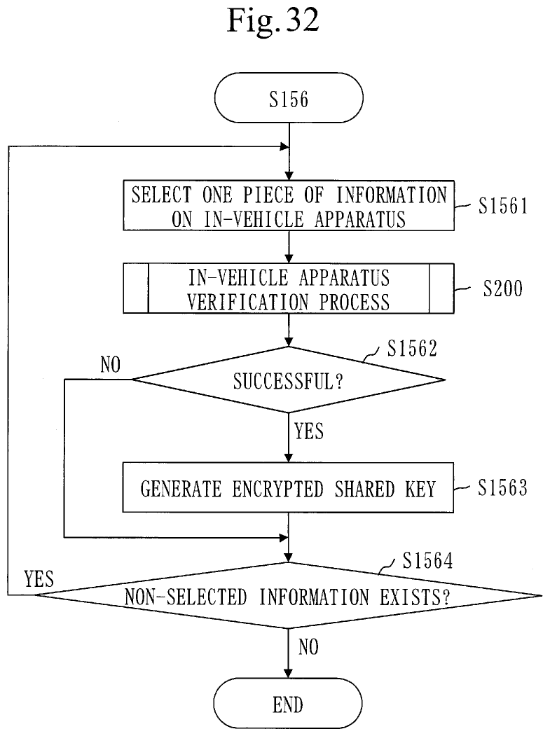

The in-vehicle apparatus verification process and the encrypted shared key generation process (S156) will be described in detail with referring to FIG. 32.

In step S1561, the verification unit 114 selects one piece of information on an in-vehicle apparatus in accordance with the arrangement order in the sort information data.

In the case of the sort information data 70 of FIG. 30, information on each in-vehicle apparatus is selected as follows.

In first step S1561, the verification unit 114 selects information on the third in-vehicle apparatus 800.

In second step S1561, the verification unit 114 selects information on the second in-vehicle apparatus 700.

In third step S1561, the verification unit 114 selects information on the fourth in-vehicle apparatus 900.

In fourth step S1561, the verification unit 114 selects information on the first in-vehicle apparatus 600.

Step S200 is an in-vehicle apparatus verification process.

In step S200, the verification unit 114 performs verification on an in-vehicle apparatus using selected in-vehicle apparatus information.

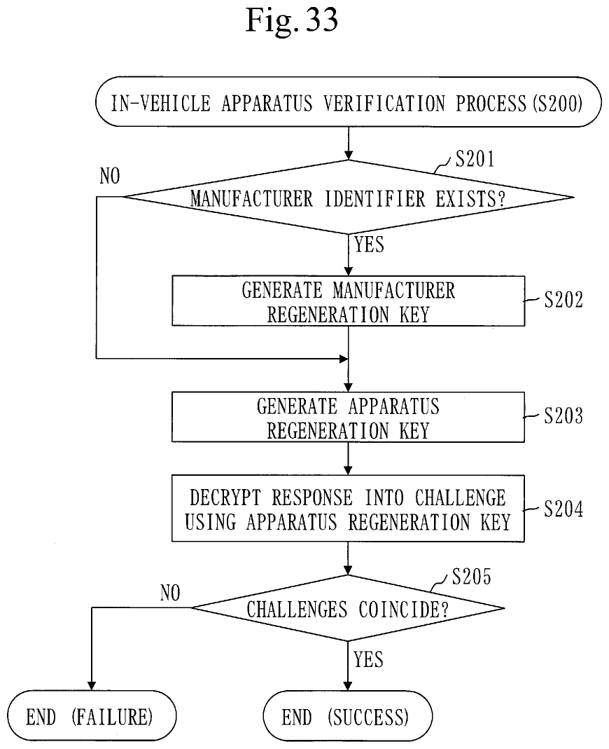

The in-vehicle apparatus verification process (S200) will be described in detail with referring to FIG. 33.

In step S201, the verification unit 114 determines whether a manufacturer identifier exists in the selected in-vehicle apparatus information.

When the in-vehicle apparatus information selected from the sort information data 70 of FIG. 30 is information on the third in-vehicle apparatus 800, a manufacturer identifier does not exist.

When the in-vehicle apparatus information selected from the sort information data 70 of FIG. 30 is information on the second in-vehicle apparatus 700, the third manufacturer identifier 721 exists.

When the in-vehicle apparatus information selected from the sort information data 70 of FIG. 30 is information on the fourth in-vehicle apparatus 900, a manufacturer identifier does not exist.

When the in-vehicle apparatus information selected from the sort information data 70 of FIG. 30 is information on the first in-vehicle apparatus 600, the second manufacturer identifier 621 exists.

If a manufacturer identifier exists in the selected in-vehicle apparatus information, the processing proceeds to step S202.

If a manufacturer identifier does not exist in the selected in-vehicle apparatus information, the processing proceeds to step S203.

In step S202, the manufacturer key generation unit 112 acquires a manufacturer identifier from the selected in-vehicle apparatus information.

Then, the manufacturer key generation unit 112 generates a manufacturer key using the master key 121 and the manufacturer identifier. The generated manufacturer key is referred to as a manufacturer regeneration key.

A method of generating the manufacturer regeneration key is the same as the method of manufacturing the manufacturer key in step S103.

When the in-vehicle apparatus information selected from the sort information data 70 of FIG. 30 is information on the second in-vehicle apparatus 700, the manufacturer key generation unit 112 generates a third manufacturer key using the master key 121 and the third manufacturer identifier 721. The generated third manufacturer key is referred to as a third manufacturer regeneration key.

When the in-vehicle apparatus information selected from the sort information data 70 of FIG. 30 is information on the first in-vehicle apparatus 600, the manufacturer key generation unit 112 generates a second manufacturer key using the master key 121 and the second manufacturer identifier 621. The generated second manufacturer key is referred to as a second manufacturer regeneration key.

In step S203, the apparatus key generation unit 113 acquires an in-vehicle apparatus identifier from the selected in-vehicle apparatus information.

The apparatus key generation unit 113 then generates an apparatus key using the manufacturer regeneration key and the in-vehicle apparatus identifier. The generated apparatus key is referred to as an apparatus regeneration key. A method of generating the apparatus regeneration key is the same as the method of generating an apparatus key in step S107.

The manufacturer regeneration key to be used is the manufacturer regeneration key generated in step S202, or a corresponding manufacturer regeneration key.

The corresponding manufacturer regeneration key is a manufacturer regeneration key generated using a manufacturer identifier coinciding with a manufacturer identifier of an in-vehicle apparatus corresponding to the selected information.

When the manufacturer of the in-vehicle apparatus corresponding to the selected information is the same as the manufacturer of the gateway 500, the corresponding manufacturer regeneration key is the first manufacturer identifier 521 included in the information on the gateway 500.

When the manufacturer of the in-vehicle apparatus corresponding to the selected information is different from the manufacturer of the gateway 500 and is the same as the manufacturer of another in-vehicle apparatus, the corresponding manufacturer regeneration key is a manufacturer identifier included in the information on another in-vehicle apparatus.

When the in-vehicle apparatus information selected from the sort information data 70 of FIG. 30 is information on the third in-vehicle apparatus 800, the apparatus key generation unit 113 generates a third in-vehicle apparatus key using the first manufacturer regeneration key and the third in-vehicle apparatus identifier 822. The generated third in-vehicle apparatus key is referred to as a third in-vehicle apparatus regeneration key.

When the in-vehicle apparatus information selected from the sort information data 70 of FIG. 30 is information on the second in-vehicle apparatus 700, the apparatus key generation unit 113 generates a second in-vehicle apparatus key using the third manufacturer regeneration key and the second in-vehicle apparatus identifier 722. The generated second in-vehicle apparatus key is referred to as a second in-vehicle apparatus regeneration key.

When the in-vehicle apparatus information selected from the sort information data 70 of FIG. 30 is information on the fourth in-vehicle apparatus 900, the apparatus key generation unit 113 generates a fourth in-vehicle apparatus key using the third manufacturer regeneration key and the fourth in-vehicle apparatus identifier 922. The generated fourth in-vehicle apparatus key is referred to as a fourth in-vehicle apparatus regeneration key.

When the in-vehicle apparatus information selected from the sort information data 70 of FIG. 30 is information on the first in-vehicle apparatus 600, the apparatus key generation unit 113 generates a first in-vehicle apparatus key using the second manufacturer regeneration key and the first in-vehicle apparatus identifier 622. The generated first in-vehicle apparatus key is referred to as a first in-vehicle apparatus regeneration key.

In step S204, the verification unit 114 acquires a response from the selected in-vehicle apparatus information.

The verification unit 114 then decrypts the response into a challenge using an apparatus regeneration key. A cryptographic algorithm used for decryption is the same as the cryptographic algorithm used for generation of the response (step S122 of FIG. 24).

When the in-vehicle apparatus information selected from the sort information data 70 of FIG. 30 is information on the third in-vehicle apparatus 800, the verification unit 114 decrypts the response 51 into a challenge using the third in-vehicle apparatus regeneration key.

When the in-vehicle apparatus information selected from the sort information data 70 of FIG. 30 is information on the second in-vehicle apparatus 700, the verification unit 114 decrypts the response 41 into a challenge using the second in-vehicle apparatus regeneration key.

When the in-vehicle apparatus information selected from the sort information data 70 of FIG. 30 is information on the fourth in-vehicle apparatus 900, the verification unit 114 decrypts the response 61 into a challenge using the fourth in-vehicle apparatus regeneration key.

When the in-vehicle apparatus information selected from the sort information data 70 of FIG. 30 is information on the first in-vehicle apparatus 600, the verification unit 114 decrypts the response 31 into a challenge using the first in-vehicle apparatus regeneration key.

Instep S205, the verification unit 114 acquires the challenge 21 from the information, included in the sort information data 70, on the gateway 500.

The verification unit 114 then compares the challenge obtained by decryption with the challenge 21.

If the challenge obtained by decryption coincides with the challenge 21, the verification is successful.

If the challenge obtained by decryption does not coincide with the challenge 21, the verification fails.

Back to FIG. 32, description continues from step S1562.

In step S1562, the verification unit 114 determines whether the verification on the in-vehicle apparatus is successful.

If the verification on the in-vehicle apparatus is successful, the processing proceeds to step S1563.

If the verification on the in-vehicle apparatus fails, the processing proceeds to step S1564.

Step S1563 is an encrypted shared key generation process.

In step S1563, the shared key encryption unit 116 encrypts a shared key using an apparatus regeneration key. Hence, an encrypted shared key is generated.

A method of generating the encrypted shared key is the same as the method of generating an encrypted shared key for the gateway 500 in step S155.

When the selected in-vehicle apparatus information is information on the third in-vehicle apparatus 800, the shared key encryption unit 116 encrypts the shared key using the third apparatus regeneration key. Hence, an encrypted regeneration key for the third in-vehicle apparatus 800 is generated.

When the selected in-vehicle apparatus information is information on the second in-vehicle apparatus 700, the shared key encryption unit 116 encrypts the shared key using the second apparatus regeneration key. Hence, an encrypted regeneration key for the second in-vehicle apparatus 700 is generated.

When the selected in-vehicle apparatus information is information on the fourth in-vehicle apparatus 900, the shared key encryption unit 116 encrypts the shared key using the fourth apparatus regeneration key. Hence, an encrypted regeneration key for the fourth in-vehicle apparatus 900 is generated.

When the selected in-vehicle apparatus information is information on the first in-vehicle apparatus 600, the shared key encryption unit 116 encrypts the shared key using the first apparatus regeneration key. Hence, an encrypted regeneration key for the first in-vehicle apparatus 600 is generated.

In step S1564, the verification unit 114 determines whether in-vehicle apparatus information not selected from the sort information data exists.

If a non-selected in-vehicle apparatus information exists, the processing proceeds to step S1561.

If a non-selected in-vehicle apparatus information does not exist, the processing ends.

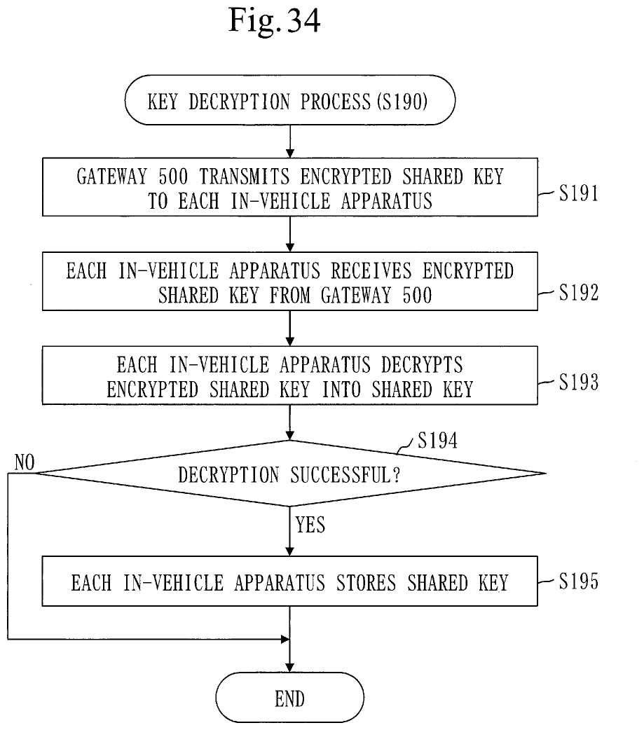

The key decryption process (S190) will be described with referring to FIG. 34.

The key decryption process (S190) is a process for each in-vehicle apparatus to decrypt an encrypted shared key into a shared key.

In step S191, the key distribution unit 515 of the gateway 500 acquires encrypted shared keys of individual in-vehicle apparatuses from the key reply.

The key distribution unit 515 then transmits the encrypted shared keys to corresponding in-vehicle apparatuses via the transmission unit 532.

Specifically, the key distribution unit 515 transmits the encrypted shared key of the first in-vehicle apparatus 600 to the first in-vehicle apparatus 600.

The key distribution unit 515 transmits the encrypted shared key of the second in-vehicle apparatus 700 to the second in-vehicle apparatus 700.

The key distribution unit 515 transmits the encrypted shared key of the third in-vehicle apparatus 800 to the third in-vehicle apparatus 800.

The key distribution unit 515 transmits the encrypted shared key of the fourth in-vehicle apparatus 900 to the fourth in-vehicle apparatus 900.

The key distribution unit 515 may transmit the encrypted shared keys of the individual in-vehicle apparatuses by broadcast. That is, the key distribution unit 515 may transmit the encrypted shared keys of the individual in-vehicle apparatuses to all the in-vehicle apparatuses at once.

In this case, each in-vehicle apparatus receives one or more encrypted shared keys and selects an encrypted shared key of its own from the received one or more encrypted shared keys.

In step S192, each in-vehicle apparatus receives an encrypted shared key from the gateway 500.

Specifically, the reception unit 631 of the first in-vehicle apparatus 600 receives the encrypted shared key of the first in-vehicle apparatus 600.

The reception unit 731 of the second in-vehicle apparatus 700 receives the encrypted shared key of the second in-vehicle apparatus 700.

The reception unit 831 of the third in-vehicle apparatus 800 receives the encrypted shared key of the third in-vehicle apparatus 800.

The reception unit 931 of the fourth in-vehicle apparatus 900 receives the encrypted shared key of the fourth in-vehicle apparatus 900.

In step S193, each in-vehicle apparatus decrypts the encrypted shared key into a shared key as follows. When the decryption is successful, a shared key can be obtained.

The key decryption unit 612 of the first in-vehicle apparatus 600 decrypts the encrypted shared key of the first in-vehicle apparatus 600 into a shared key using the first in-vehicle apparatus key 623. Specifically, the key decryption unit 612 decrypts the encrypted shared key of the first in-vehicle apparatus 600 into a shared key in accordance with the authentication cryptography using the first in-vehicle apparatus key 623. More specifically, the key decryption unit 612 takes as input the first in-vehicle apparatus key 623 and the encrypted shared key of the first in-vehicle apparatus 600 and executes a decryption function of the authentication cryptography.

In decryption of the authentication cryptography, authentication and decryption are performed. When the authentication is successful, the decryption is successful. When the authentication fails, the decryption fails.

A shared key obtained when the decryption is successful is the shared key 624.

Likewise, the key decryption unit 712 of the second in-vehicle apparatus 700 decrypts the encrypted shared key of the second in-vehicle apparatus 700 into a shared key using the second in-vehicle apparatus key 723. The shared key obtained when the decryption is successful is the shared key 724.

Likewise, the key decryption unit 812 of the third in-vehicle apparatus 800 decrypts the encrypted shared key of the third in-vehicle apparatus 800 into a shared key using the third in-vehicle apparatus key 823. The shared key obtained when the decryption is successful is the shared key 824.

Likewise, the key decryption unit 912 of the fourth in-vehicle apparatus 900 decrypts the encrypted shared key of the fourth in-vehicle apparatus 900 into a shared key using the fourth in-vehicle apparatus key 923. The shared key obtained when the decryption is successful is the shared key 924.

A decryption method in the second in-vehicle apparatus 700, third in-vehicle apparatus 800, and fourth in-vehicle apparatus 900 is the same as the above-mentioned method in the first in-vehicle apparatus 600.

In step S194, each in-vehicle apparatus determines whether the encrypted shared key is successfully decrypted into a shared key. That is, each in-vehicle apparatus determines whether the decryption is successful.

Specifically, the key decryption unit 612 of the first in-vehicle apparatus 600 determines whether the encrypted shared key of the first in-vehicle apparatus 600 is successfully decrypted into the shared key 624.

The key decryption unit 712 of the second in-vehicle apparatus 700 determines whether the encrypted shared key of the second in-vehicle apparatus 700 is successfully decrypted into the shared key 724.

The key decryption unit 812 of the third in-vehicle apparatus 800 determines whether the encrypted shared key of the third in-vehicle apparatus 800 is successfully decrypted into the shared key 824.

The key decryption unit 912 of the fourth in-vehicle apparatus 900 determines whether the encrypted shared key of the fourth in-vehicle apparatus 900 is successfully decrypted into the shared key 924.

In each in-vehicle apparatus in which the decryption is successful, the processing proceeds to step S195.

In each in-vehicle apparatus in which the decryption fails, the processing ends. In this case, each in-vehicle apparatus cannot share shared keys with the gateway 500 and the other in-vehicle apparatuses.

In step S195, each in-vehicle apparatus in which the decryption is successful stores the shared key obtained by decryption.

Specifically, the storage unit 620 of the first in-vehicle apparatus 600 stores the shared key 624.

The storage unit 720 of the second in-vehicle apparatus 700 stores the shared key 724.

The storage unit 820 of the third in-vehicle apparatus 800 stores the shared key 824.

The storage unit 920 of the fourth in-vehicle apparatus 900 stores the shared key 924.

Each of the shared key 624, shared key 724, shared key 824, and shared key 924 coincides with the shared key 524 stored in the storage unit 520 of the gateway 500. That is, the shared key 524, the shared key 624, the shared key 724, and the shared key 824 coincide with each other.

### Effect of Embodiment 1

In the key sharing system 10, the gateway 500, the first in-vehicle apparatus 600, the second in-vehicle apparatus 700, the third in-vehicle apparatus 800, and the fourth in-vehicle apparatus 900 share the same shared keys.

After the shared keys are shared, the gateway 500, the first in-vehicle apparatus 600, the second in-vehicle apparatus 700, the third in-vehicle apparatus 800, and the fourth in-vehicle apparatus 900 utilize the shared keys when they communicate with each other. For example, the shared keys are used for apparatus authentication, message authentication, message encryption, and so on.

Hence, data can be communicated securely among the gateway 500, the first in-vehicle apparatus 600, the second in-vehicle apparatus 700, the third in-vehicle apparatus 800, and the fourth in-vehicle apparatus 900.

Data exchanged for the purpose of key sharing between the key management device 100 and the gateway 500 are only the key request and the key reply.

Hence, the whole processing time required for key sharing can be shortened.

In Embodiment 1, the number of in-vehicle apparatuses mounted in the vehicle 15 is 5. In an actual automobile, approximately several tens to one hundred and several tens of in-vehicle apparatuses are mounted.

Therefore, in an actual automobile, the effect of reducing the amount of data exchanged between the key management device 100 and the gateway 500 is large.

In the key management device 100, verification on the in-vehicle apparatus may be performed by processing the information on each in-vehicle apparatus in accordance with the arrangement order in the key request.

As a result, the number of times a manufacturer key is regenerated can be minimized. Accordingly, the processing load acting on the key management device 100 can be reduced.

*** Other Configurations ***

The number of apparatus manufacturers may be one or two, or may be four or more.

The number of in-vehicle apparatuses may be any one out of one to three, or may be five or more.

For the sake of generation of a response in challenge response authentication, in encryption, it is desired to use a random number as Nonce (Number used once). This will be specifically explained below.

In step S122 of FIG. 24, each in-vehicle apparatus generates a random number and uses the generated random number as Nonce. That is, each in-vehicle apparatus does not use the generated random number in the next and subsequent times. Each in-vehicle apparatus generates a response by encrypting Nonce using an apparatus key.

In step S123 of FIG. 24, each in-vehicle apparatus includes Nonce into the in-vehicle apparatus information and generates an information reply that includes the in-vehicle apparatus information.

In step S140 of FIG. 21, the gateway 500 transmits a key request to the key management device 100. The key request includes information on each in-vehicle apparatus, and the information on each in-vehicle apparatus includes Nonce of that in-vehicle apparatus.

In step S204 of FIG. 33, the key management device 100 decrypts a response of each in-vehicle apparatus into a challenge using Nonce of that in-vehicle apparatus.

The shared keys which the gateway 500 shares with the individual in-vehicle apparatuses may differ from one in-vehicle apparatus to another. That is, the gateway 500 may share the first shared key with the first in-vehicle apparatus 600, the second shared key with the second in-vehicle apparatus 700, the third shared key with the third in-vehicle apparatus 800, and the fourth shared key with the fourth in-vehicle apparatus 900. This will be specifically explained below.

In step S154 of FIG. 31, the key management device 100 generates four shared keys which are the first shared key, the second shared key, the third shared key, and the fourth shared key. The four shared keys differ from each other.

In step S155 of FIG. 31, the key management device 100 generates an encrypted shared key of the gateway 500 by encrypting a set of the first shared key, second shared key, third shared key, and fourth shared key.

In step S156 of FIG. 31, the key management device 100 encrypts the first shared key to generate an encrypted shared key of the first in-vehicle apparatus 600. The key management device 100 encrypts the second shared key to generate an encrypted shared key of the second in-vehicle apparatus 700. The key management device 100 encrypts the third shared key to generate an encrypted shared key of the third in-vehicle apparatus 800. The key management device 100 encrypts the fourth shared key to generate an encrypted shared key of the fourth in-vehicle apparatus 900.

The gateway 500 may share a plurality of shared keys with each in-vehicle apparatus. This will be specifically explained below.

In step S154 of FIG. 31, the key management device 100 generates a plurality of shared keys.

In step S155 of FIG. 31, the key management device 100 generates a plurality of encrypted shared keys of the gateway 500 by encrypting each shared key using the gateway regeneration key.

In step S156 of FIG. 31, the key management device 100 generates a plurality of encrypted shared keys of each in-vehicle apparatus by encrypting each shared key using the apparatus regeneration key of that in-vehicle apparatus. That is, the key management device 100 generates a plurality of encrypted shared keys of the first in-vehicle apparatus 600, a plurality of encrypted shared keys of the second in-vehicle apparatus 700, a plurality of encrypted shared keys of the third in-vehicle apparatus 800, and a plurality of encrypted shared keys of the fourth in-vehicle apparatus 900.

Storing the shared keys by the gateway 500 and storing the shared keys by each in-vehicle apparatus may be performed after verification in that in-vehicle apparatus is successfully performed. This will be specifically explained below.

In step S1904 of FIG. 34, each in-vehicle apparatus in which decryption of the shared key is successful transmits a success notice to the gateway 500. Each in-vehicle apparatus in which decryption of the shared key fails transmits a failure notice to the gateway 500.

The gateway 500 stores the shared keys when it receives a success notice from all the in-vehicle apparatuses, not when decryption of the shared keys are successful in step S180 of FIG. 21. The gateway 500 does not store shared keys when it receives a failure notice from at least one in-vehicle apparatus instead of a success notice.

Upon reception of a success notice from all the in-vehicle apparatuses, the gateway 500 transmits a sharing notice to all the in-vehicle apparatuses. Each in-vehicle apparatus stores shared keys when it receives a sharing notice from the gateway 500.

The gateway 500 may be an apparatus provided to an outside of the vehicle 15.

More specifically, the gateway 500 may be an apparatus for maintaining each in-vehicle apparatus from the outside of the vehicle 15.

### Embodiment 2

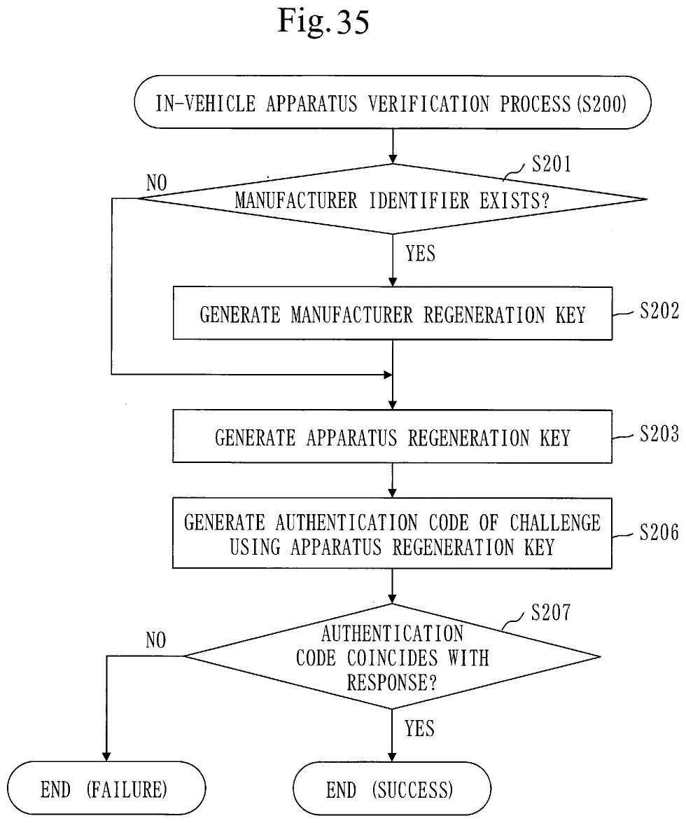

A mode in which a response in challenge response authentication is an authentication code will be described with referring to FIG. 35 mainly regarding differences from Embodiment 1.

*** Description of Configuration *** A configuration of a key sharing system 10 is the same as the configuration of Embodiment 1 (see FIGS. 1 to 19).

*** Description of Operation ***

The apparatus key setting process has been described in Embodiment 1 referring to FIG. 20.

A flow of a key sharing process is the same as the flow in Embodiment 1 (see FIG. 21).

Note that a response generated in an information transmission process (S120) is not an encrypted challenge but an authentication code of the challenge. This will be specifically described below.

In step S122, each in-vehicle apparatus acquires a challenge from a received information request and generates a response corresponding to the challenge and the apparatus key.

Specifically, each in-vehicle apparatus generates an authentication code of the challenge using the apparatus key. The generated authentication code is the response.

More specifically, each in-vehicle apparatus takes as input the challenge and the apparatus key and executes a hash function to calculate a hash value. The calculated hash value is the authentication code of the challenge.

That is, an information reply unit 611 of a first in-vehicle apparatus 600 acquires a challenge 21 from a received information request 20 and generates an authentication code of the challenge 21 using a first in-vehicle apparatus key 623. The generated authentication code is a response 31.

An information reply unit 711 of a second in-vehicle apparatus 700 acquires the challenge 21 from the received information request 20 and generates an authentication code of the challenge 21 using a second in-vehicle apparatus key 723. The generated authentication code is a response 41.

An information reply unit 811 of a third in-vehicle apparatus 800 acquires the challenge 21 from the received information request 20 and generates an authentication code of the challenge 21 using a third in-vehicle apparatus key 823. The generated authentication code is a response 51.

An information reply unit 911 of a fourth in-vehicle apparatus 900 acquires the challenge 21 from the received information request 20 and generates an authentication code of the challenge 21 using the fourth in-vehicle apparatus key 923. The generated authentication code is a response 61.

An in-vehicle apparatus verification process (S200) will now be described in detail with referring to FIG. 35.

The in-vehicle apparatus verification process (S200) of FIG. 35 corresponds to the in-vehicle apparatus verification process (S200) of Embodiment 2. That is, in Embodiment 2, the in-vehicle apparatus verification process (S200) of FIG. 35 is executed in place of the in-vehicle apparatus verification process (S200) described in Embodiment 1 with referring to FIG. 33.

Step S201 to step S203 have been described in Embodiment 1 (see FIG. 33).

In step S206, a verification unit 114 acquires the challenge 21 from information on the gateway 500 included in sort information data 70.

The verification unit 114 generates an authentication code of the challenge 21 using an apparatus regeneration key. Specifically, the verification unit 114 takes as input the challenge 21 and the apparatus regeneration key and executes a hash function to calculate a hash value. The calculated hash value is the authentication code of the challenge 21. The hash function employed is the same as the hash function employed in step S122 of FIG. 21.

When in-vehicle apparatus information selected from the sort information data 70 of FIG. 30 is information on the third in-vehicle apparatus 800, the verification unit 114 generates an authentication code of the challenge 21 using a third in-vehicle apparatus regeneration key. The generated authentication code is referred to as a third authentication code.

When in-vehicle apparatus information selected from the sort information data 70 of FIG. 30 is information on the second in-vehicle apparatus 700, the verification unit 114 generates an authentication code of the challenge 21 using a second in-vehicle apparatus regeneration key. The generated authentication code is referred to as a second authentication code.

When in-vehicle apparatus information selected from the sort information data 70 of FIG. 30 is information on the fourth in-vehicle apparatus 900, the verification unit 114 generates an authentication code of the challenge 21 using a fourth in-vehicle apparatus regeneration key. The generated authentication code is referred to as a fourth authentication code.

When in-vehicle apparatus information selected from the sort information data 70 of FIG. 30 is information on the first in-vehicle apparatus 600, the verification unit 114 generates an authentication code of the challenge 21 using a first in-vehicle apparatus regeneration key. The generated authentication code is referred to as a first authentication code.

In step S207, the verification unit 114 acquires a response from the selected in-vehicle apparatus information.

The verification unit 114 then compares the generated authentication code with the acquired response.

If the generated authentication code coincides with the acquired response, the verification is successful.

If the generated authentication code does not coincide with the acquired response, the verification fails.

When the in-vehicle apparatus information selected from the sort information data 70 of FIG. 30 is information on the third in-vehicle apparatus 800, the verification unit 114 compares the third authentication code with the response 51.

When the in-vehicle apparatus information selected from the sort information data 70 of FIG. 30 is information on the second in-vehicle apparatus 700, the verification unit 114 compares the second authentication code with the response 41.

When the in-vehicle apparatus information selected from the sort information data 70 of FIG. 30 is information on the fourth in-vehicle apparatus 900, the verification unit 114 compares the fourth authentication code with the response 61.

When the in-vehicle apparatus information selected from the sort information data 70 of FIG. 30 is information on the first in-vehicle apparatus 600, the verification unit 114 compares the first authentication code with the response 31.

### Effect of Embodiment 2

Embodiment 2 can provide the same effect as that of Embodiment 1.

That is, data can be communicated securely among the gateway 500, the first in-vehicle apparatus 600, the second in-vehicle apparatus 700, the third in-vehicle apparatus 800, and the fourth in-vehicle apparatus 900 by sharing the shared keys.

### Embodiment 3

A mode in which a plurality of in-vehicle apparatuses mounted in a vehicle 15 are grouped will be described mainly regarding differences from Embodiment 1.

*** Description of Configuration ***

A configuration of a key sharing system 10 is the same as the configuration in Embodiment 1 (see FIG. 1 to FIG. 19).

Note that a network in the vehicle 15 is divided into a plurality of domains. A domain is a unit that makes up an individual network. For example, the network in the vehicle 15 is divided into a body-related domain, an information-related domain, and a power-related domain.

A first in-vehicle apparatus 600, a second in-vehicle apparatus 700, a third in-vehicle apparatus 800, and a fourth in-vehicle apparatus 900 belong to the same domain.

Although not illustrated, one or more in-vehicle apparatuses belonging to another domain are mounted in the vehicle 15.

Note that a gateway 500 belongs to all domains.

*** Description of Operation ***

An apparatus key setting process has been described in Embodiment 1 referring to FIG. 20, and is executed for all domains. Note that the apparatus setting process may be executed for each domain separately.

A key sharing process has been described in Embodiment 1 referring to FIG. 21. Note that the key sharing process is executed in units of domains.

For example, first, a key sharing process on the body-related domain is executed. Then, a key sharing process on the information-related domain is executed. Finally, a key sharing process on the power-related domain is executed.

### Effect of Embodiment 3

The plurality of in-vehicle apparatuses mounted in the vehicle 15 are grouped. Key sharing can be performed at a different timing from one group to another.

*** Other Configurations ***

The response in challenge response authentication may be an authentication code of a challenge, as in Embodiment 2, instead of an encrypted challenge.

### Embodiment 4

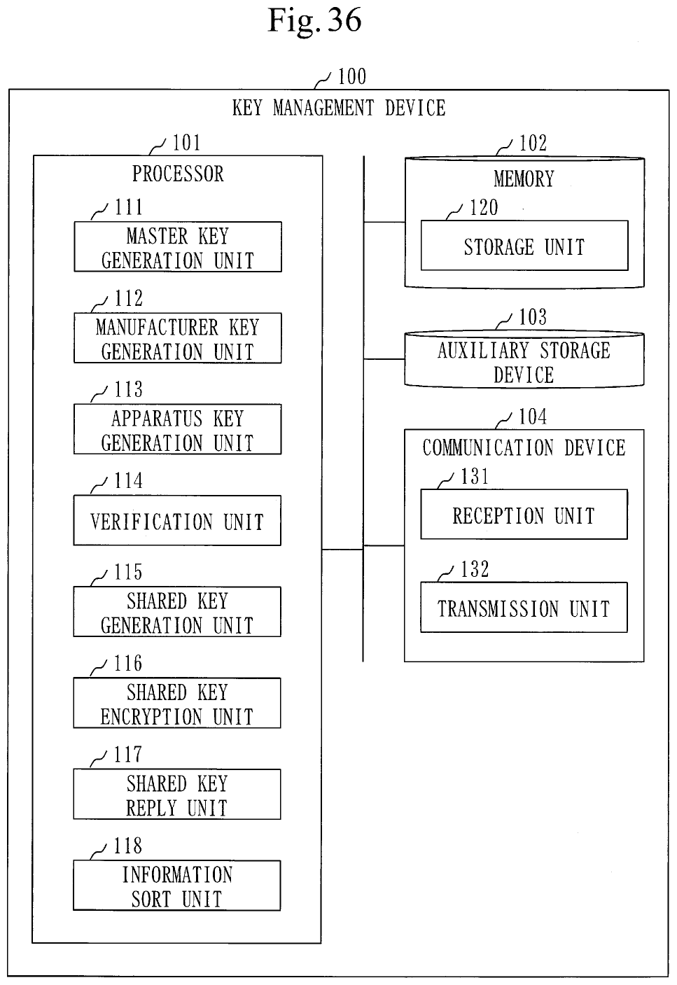

A mode in which a key management device 100 sorts information on each in-vehicle apparatus on behalf of a gateway 500 will be described with referring to FIG. 36 to FIG. 39 mainly regarding differences from Embodiment 1.

*** Description of Configuration ***

A configuration of a key sharing system 10 is the same as the configuration in Embodiment 1 (see FIG. 1).

Note that a configuration of the key management device 100 and a configuration of a configuration of the gateway 500 are partly different from their counterparts in Embodiment 1.

The configuration of the key management device 100 will be described with referring to FIG. 36.

The key management device 100 is further provided with an information sort unit 118.

A key management program causes the computer to further function as the information sort unit 118.

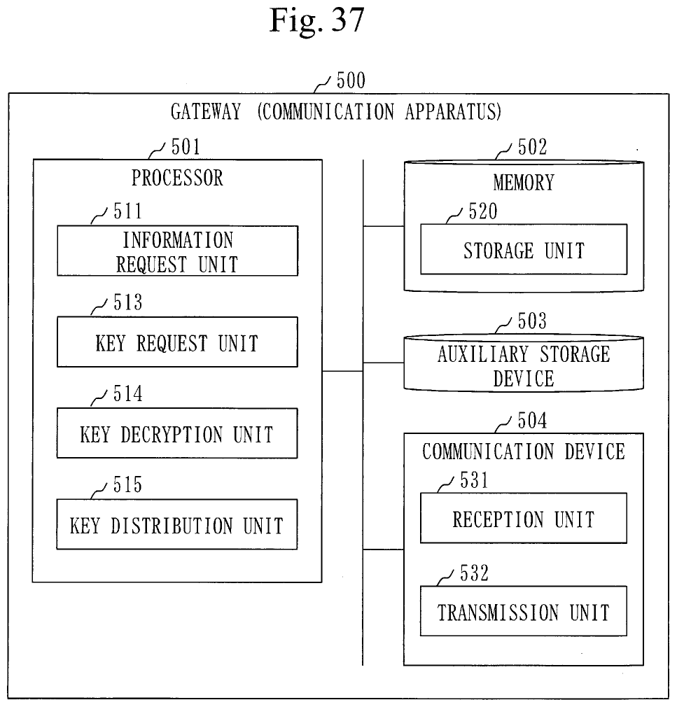

The configuration of the gateway 500 will be described with referring to FIG. 37.

The gateway 500 is not provided with the information sort unit 512 in Embodiment 1 (see FIG. 10).

*** Description of Operation ***

An apparatus key setting process has been described in Embodiment 1 with referring to FIG. 20.

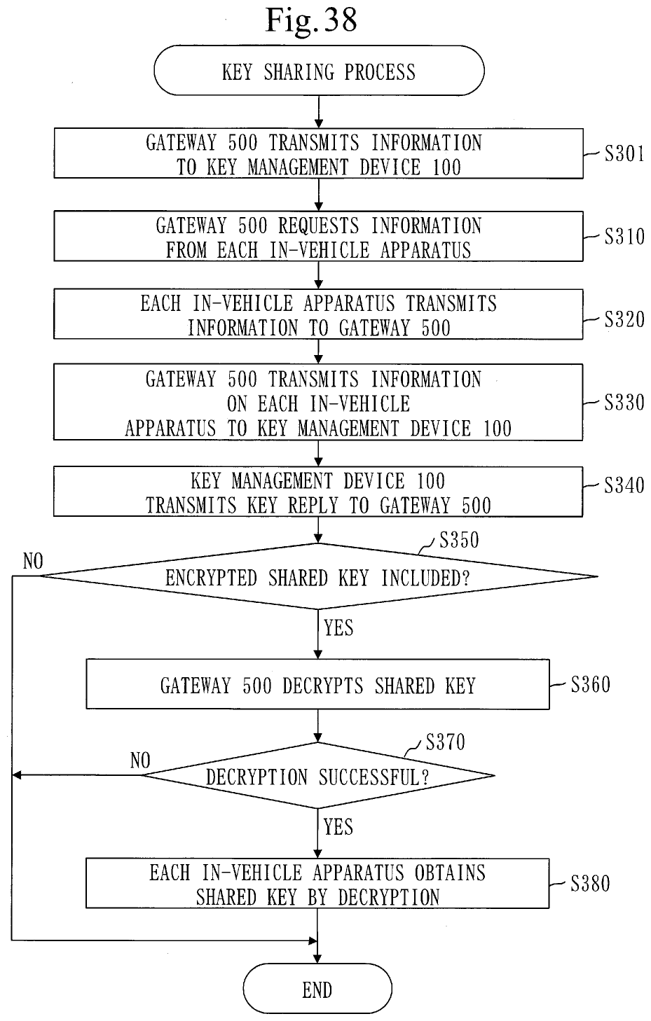

A key sharing process will now be described with referring to FIG. 38.

In step S301, the gateway 500 transmits information on the gateway 500 to the key management device 100.

Specifically, a key request unit 513 of the gateway 500 transmits the information on the gateway 500 to the key management device 100 via a transmission unit 532. The information on the gateway 500 includes a first manufacturer identifier 521, a gateway identifier 522, and a first manufacturer identifier 521.

In step S310, the gateway 500 requests information from each in-vehicle apparatus.

Step S310 is the same as step S110 in Embodiment 1 (see FIG. 21).

In step S320, each in-vehicle apparatus transmits information to the gateway 500.

Step S320 is the same as step S120 in Embodiment 1 (see FIG. 21).

In step S330, an information request unit 511 of the gateway 500 receives information from each in-vehicle apparatus via a reception unit 531.

Each time information is received, the key request unit 513 of the gateway 500 transmits the received information to the key management device 100 via the reception unit 531.

Step S330 corresponds to step S140 in Embodiment 1 (see FIG. 21).

In step S340, the key management device 100 performs verification on each in-vehicle apparatus and transmits a key reply including an encrypted shared key of the gateway 500 and encrypted shared keys of individual right in-vehicle apparatuses to the gateway 500.

Step S340 corresponds to step S150 in Embodiment 1 (see FIG. 21).

The key reply process (S340) will be described later in detail.

In step S350, the information request unit 511 of the gateway 500 receives a key reply from the key management device 100 via the reception unit 531.

A key decryption unit 514 of the gateway 500 determines whether the encrypted shared keys of all the in-vehicle apparatuses are included in the key reply.

If the encrypted shared keys of all the in-vehicle apparatuses are included in the key reply, the processing proceeds to step S360.

If an encrypted shared key of at least one in-vehicle apparatus is not included in the key reply, the gateway 500 does not share keys with the in-vehicle apparatuses, and the processing ends.

Step S350 is the same as step S160 in Embodiment 1 (see FIG. 21).

In step S360, the key decryption unit 514 of the gateway 500 decrypts the encrypted shared key for the gateway 500 into a shared key using the gateway key 523.

When the decryption is successful, a shared key is obtained.

Step S360 is the same as step S170 in Embodiment 1 (see FIG. 21).

In step S370, a key distribution unit 515 of the gateway 500 determines whether the encrypted shared key of the gateway 500 is successfully decrypted into a shared key. That is, the key distribution unit 515 determines whether the decryption is successful.

If the decryption is successful, a storage unit 520 stores the shared key obtained by decryption. The shared key to be stored is a shared key 524. After that, the processing proceeds to step S380.

If the decryption fails, the key distribution unit 515 performs an error process. After that, the processing ends. In this case, the gateway 500 cannot share shared keys with the in-vehicle apparatuses.

Step S370 is the same as step S180 in Embodiment 1 (see FIG. 21).

In step S380, the gateway 500 transmits an encrypted shared key to each in-vehicle apparatus.

Then, each in-vehicle apparatus receives the encrypted shared key and decrypts the encrypted shared key into a shared key.

Step S380 is the same as step S190 in Embodiment 1 (see FIG. 21).

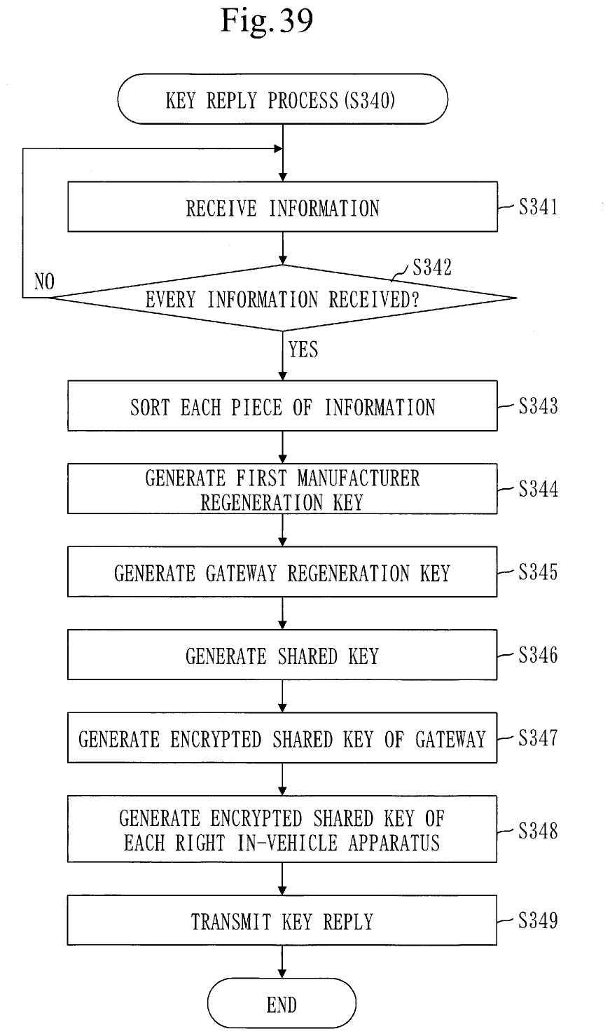

The key reply process (S340) will be described in detail with referring to FIG. 39.

In step S341, a reception unit 131 of the key management device 100 receives information on the gateway 500 or information on each in-vehicle apparatus.

In step S342, the information sort unit 118 determines whether the information on the gateway 500 and the information on each of all the in-vehicle apparatuses are received. That is, the information sort unit 118 determines whether all information is received.

If all information is received, the processing proceeds to step S343.

If at least one piece of information is not received, the processing proceeds to step S341.

In step S343, the information sort unit 118 sorts the received information.

A procedure of a sort process (S343) is the same as the procedure of the sort process (S130) described in Embodiment 1 with referring to FIG. 29.

In step S344 to step S349, the key management device 100 verifies in-vehicle apparatuses and transmits a key reply including the encrypted shared key of the gateway 500 and the encrypted shared keys of the right in-vehicle apparatuses to the gateway 500.

Step S344 to step S349 are the same as step S152 to step S157 of the key reply process (S150) described in Embodiment 1 with referring to FIG. 31.

### Effect of Embodiment 4

In the key sharing system 10, the gateway 500, a first in-vehicle apparatus 600, a second in-vehicle apparatus 700, a third in-vehicle apparatus 800, and a fourth in-vehicle apparatus 900 share the same shared keys.

After the shared keys are shared, the gateway 500, the first in-vehicle apparatus 600, the second in-vehicle apparatus 700, the third in-vehicle apparatus 800, and the fourth in-vehicle apparatus 900 utilize the shared keys when they communicate with each other. For example, the shared keys are used for apparatus authentication, message authentication or message encryption, and so on.

As a result, data can be communicated securely among the gateway 500, the first in-vehicle apparatus 600, the second in-vehicle apparatus 700, the third in-vehicle apparatus 800, and the fourth in-vehicle apparatus 900.

It is not necessary for the gateway 500 to temporarily store information from all the in-vehicle apparatuses and to sort the information.

This makes it possible to reduce the processing load acting on the gateway 500.

*** Other Configurations ***

The response in challenge response authentication may be an authentication code of a challenge as in Embodiment 2, instead of an encrypted challenge.

As in Embodiment 3, the network in the vehicle 15 may be divided into a plurality of domains. Each in-vehicle apparatus may belong to any one domain, and key sharing may be performed in units of domains.

### Supplement to Embodiments

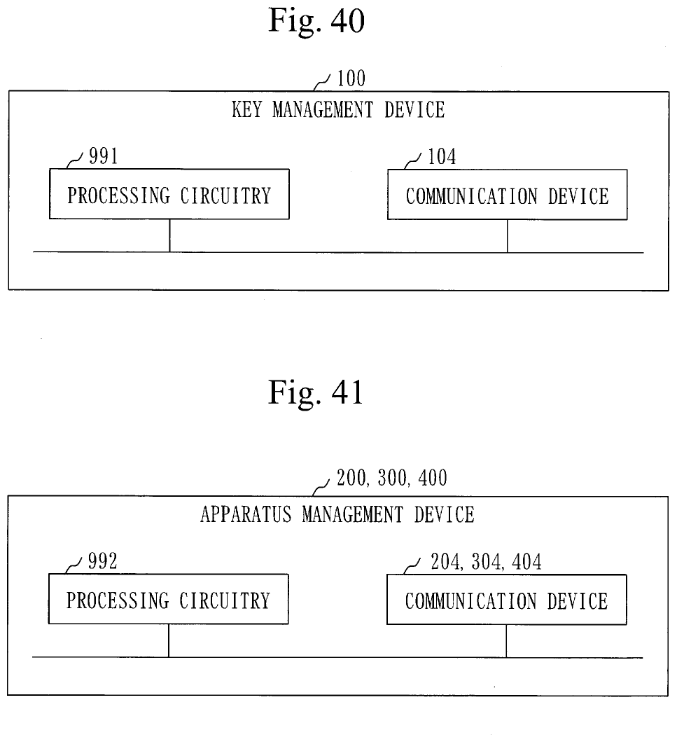

A hardware configuration of the key management device 100 will be described with referring to FIG. 40.

The key management device 100 is provided with processing circuitry 991.

The processing circuitry 991 is hardware that implements all, one, or some of the master key generation unit 111, the manufacturer key generation unit 112, the apparatus key generation unit 113, the verification unit 114, the shared key generation unit 115, the shared key encryption unit 116, the shared key reply unit 117, and the information sort unit 118.

The processing circuitry 990 may be dedicated hardware, or may be a processor 901 that executes the program stored in the memory 102.

When the processing circuitry 991 is dedicated hardware, the processing circuitry 991 is, for example, a single circuit, a composite circuit, a programmed processor, a parallel-programmed processor, an ASIC, or an FPGA; or a combination of them.

Note that ASIC is an acronym for Application Specific Integrated Circuit, and that FPGA is an acronym for Field Programmable Gate Array.

The key management device 100 may be provided with a plurality of processing circuits that replace the processing circuitry 991. The plurality of processing circuits share the role of the processing circuitry 991.

A hardware configuration of each apparatus management device (200, 300, 400) will be described with referring to FIG. 41.

Each apparatus management device is provided with processing circuitry 992.

The processing circuitry 992 is hardware that implements the apparatus key generation unit (211, 311, 411).

The processing circuitry 992 may be dedicated hardware, or the processor (201, 301, 401) that implements the program stored in the memory (202, 302, 402).

When the processing circuitry 992 is dedicated hardware, the processing circuitry 992 is, for example, a single circuit, a composite circuit, a programmed processor, a parallel-programmed processor, an ASIC, or an FPGA; or a combination of them.

Each apparatus management device may be provided with a plurality of processing circuits that replace the processing circuitry 992. The plurality of processing circuits share the role of the processing circuitry 992.

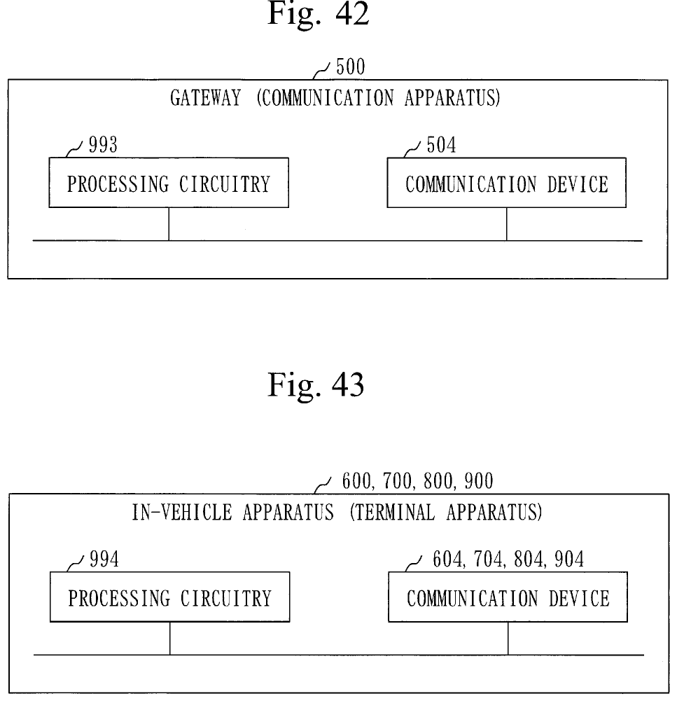

The hardware configuration of the key management device 100 will be described with referring to FIG. 42.

The key management device 100 is provided with processing circuitry 993.

The processing circuitry 993 is hardware that implements all, one, or some of the information request unit 511, the information sort unit 512, the key request unit 513, the key decryption unit 514, and the key distribution unit 515.

The processing circuitry 993 may be dedicated hardware, or may be the processor 501 that executes the program stored in the memory 502.

When the processing circuitry 993 is dedicated hardware, the processing circuitry 993 is, for example, a single circuit, a composite circuit, a programmed processor, a parallel-programmed processor, an ASIC, or an FPGA; or a combination of them.

The gateway 500 may be provided with a plurality of processing circuits that replace the processing circuitry 993. The plurality of processing circuits share the role of the processing circuitry 993.

A hardware configuration of each in-vehicle apparatus (600, 700, 800, 900) will be described with referring to FIG. 43.

Each in-vehicle apparatus is provided with processing circuitry 994.

The processing circuitry 994 is hardware that implements the information reply unit (611, 711, 811, 911) and the key decryption unit (612, 712, 812, 912).

The processing circuitry 994 may be dedicated hardware, or the processor (601, 701, 801, 901) that implements the program stored in the memory (602, 702, 802, 902).

When the processing circuitry 994 is dedicated hardware, the processing circuitry 994 is, for example, a single circuit, a composite circuit, a programmed processor, a parallel-programmed processor, an ASIC, or an FPGA; or a combination of them.

Each in-vehicle apparatus may be provided with a plurality of processing circuits that replace the processing circuitry 994. The plurality of processing circuits share the role of the processing circuitry 994.

In the key management device 100, in each apparatus management device (200, 300, 400), in the gateway 500, or in each in-vehicle apparatus (600, 700, 800, 900), one or some of the functions may be implemented by dedicated hardware and the remaining functions may be implemented by software or firmware.

In this manner, the processing circuitry (991, 992, 993, 994) can be implemented by the hardware, software, or firmware; or a combination of them.

Each embodiment is an exemplification of a preferred mode and is not intended to restrict the technical scope of the present invention. Each embodiment may be practiced partially, or in combination of another embodiment. A procedure described with using a flowchart and so on may be changed appropriately.

### REFERENCE SIGNS LIST

10: key sharing system; 11: business operator; 12: first manufacturer; 13: second manufacturer; 14: third manufacturer; 15: vehicle; 19: network; 20: information request; 21: challenge; 30: information reply; 31: response; 40: information reply; 41: response; 50: information reply; 51: response; 60: information reply; 61: response; 70: sort information data; 100: key management device; 101: processor; 102: memory; 103: auxiliary storage device; 104: communication device; 111: master key generation unit; 112: manufacturer key generation unit; 113: apparatus key generation unit; 114: verification unit; 115: shared key generation unit; 116: shared key encryption unit; 117: shared key reply unit; 118: information sort unit; 120: storage unit; 121: master key; 122: first manufacturer identifier; 123: second manufacturer identifier; 124: third manufacturer identifier; 131: reception unit; 132: transmission unit; 200: first apparatus management device; 201: processor; 202: memory; 203: auxiliary storage device; 204: communication device; 211: apparatus key generation unit; 220: storage unit; 221: first manufacturer key; 222: first manufacturer identifier; 223: gateway identifier; 224: third in-vehicle apparatus identifier; 231: reception unit; 232: transmission unit; 300: second apparatus management device; 301: processor; 302: memory; 303: auxiliary storage device; 304: communication device; 311: apparatus key generation unit; 320: storage unit; 321: second manufacturer key; 322: second manufacturer identifier; 323: first in-vehicle apparatus identifier; 331: reception unit; 332: transmission unit; 400: third apparatus management device; 401: processor; 402: memory; 403: auxiliary storage device; 404: communication device; 411: apparatus key generation unit; 420: storage unit; 421: third manufacturer key; 422: third manufacturer identifier; 423: second in-vehicle apparatus identifier; 424: fourth in-vehicle apparatus identifier; 431: reception unit; 432: transmission unit; 500: gateway; 501: processor; 502: memory; 503: auxiliary storage device; 504: communication device; 511: information request unit; 512: information sort unit; 513: key request unit; 514: key decryption unit; 515: key distribution unit; 520: storage unit; 521: first manufacturer identifier; 522: gateway identifier; 523: gateway key; 524: shared key; 531: reception unit; 532: transmission unit; 600: first in-vehicle apparatus; 601: processor; 602: memory; 603: auxiliary storage device; 604: communication device; 611: information reply unit; 612: key decryption unit; 620: storage unit; 621: second manufacturer identifier; 622: first in-vehicle apparatus identifier; 623: first in-vehicle apparatus key; 624: shared key; 631: reception unit; 632: transmission unit; 700: second in-vehicle apparatus; 701: processor; 702: memory; 703: auxiliary storage device; 704: communication device; 711: information reply unit; 712: key decryption unit; 720: storage unit; 721: third manufacturer identifier; 722: second in-vehicle apparatus identifier; 723: second in-vehicle apparatus key; 724: shared key; 731: reception unit; 732: transmission unit; 800: third in-vehicle apparatus; 801: processor; 802: memory; 803: auxiliary storage device; 804: communication device; 811: information reply unit; 812: key decryption unit; 820: storage unit; 821: first manufacturer identifier; 822: third in-vehicle apparatus identifier; 823: third in-vehicle apparatus key; 824: shared key; 831: reception unit; 832: transmission unit; 900: fourth in-vehicle apparatus; 901: processor; 902: memory; 903: auxiliary storage device; 904: communication device; 911: information reply unit; 912: key decryption unit; 920: storage unit; 921: third manufacturer identifier; 922: fourth in-vehicle apparatus identifier; 923: fourth in-vehicle apparatus key; 924: shared key; 931: reception unit; 932: transmission unit; 991: processing circuitry; 992: processing circuitry; 993: processing circuitry; 994: processing circuitry

1. A key management device comprising:
a communication device to receive a key request,
the key request including communication apparatus information and including, behind the communication apparatus information, terminal apparatus information on each of one or more terminal apparatuses,
the communication apparatus information including a communication apparatus identifier which identifies a communication apparatus, a communication manufacturer identifier which identifies a communication manufacturer being a manufacturer of the communication apparatus, and a challenge of challenge response authentication,
each terminal apparatus information including a terminal apparatus identifier which identifies a corresponding terminal apparatus and a response corresponding to the challenge and a terminal apparatus key which is stored in the corresponding terminal apparatus, the corresponding terminal apparatus being a terminal apparatus corresponding to said each terminal apparatus information, wherein if a terminal manufacturer identifier which identifies a terminal manufacturer being a manufacturer of the corresponding terminal apparatus coincides with none of the communication manufacturer identifier and a terminal manufacturer identifier which is included in another terminal apparatus information arranged ahead of each terminal apparatus information in the key request, then each terminal apparatus information includes the terminal manufacturer identifier of the corresponding terminal apparatus; and
processing circuitry
to acquire the communication apparatus information from the key request,
to generate a communication manufacturer key corresponding to the communication manufacturer identifier using the communication manufacturer identifier included in the communication apparatus information, and generate a communication apparatus key corresponding to the communication apparatus identifier using the communication manufacturer key and the communication apparatus identifier which is included in the communication apparatus information, and
to acquire each terminal apparatus information, after the communication apparatus key is generated, in accordance with an arrangement order in the key request,
if the acquired terminal apparatus information includes a terminal manufacturer identifier, the processing circuitry generating a terminal manufacturer key corresponding to the terminal manufacturer identifier using the terminal manufacturer identifier included in the acquired terminal apparatus information, and generating a terminal apparatus key corresponding to the terminal apparatus identifier using the terminal manufacturer key and a terminal apparatus identifier which is included in the acquired terminal apparatus information,
if the acquired terminal apparatus information does not include a terminal manufacturer identifier, the processing circuitry generating a terminal apparatus key corresponding to a terminal apparatus identifier included in the acquired terminal apparatus information using: a communication manufacturer key or a terminal manufacturer key each being generated with using a manufacturer identifier coinciding with a terminal manufacturer identifier of a terminal apparatus corresponding to the acquired terminal apparatus information; and the terminal apparatus identifier,
to verify each terminal apparatus based on the challenge included in the communication apparatus information, the response included in each terminal apparatus information, and each generated terminal apparatus key, and
to generate an encrypted shared key of the communication apparatus by encrypting a shared key, shared by the communication apparatus and each terminal apparatus, using the generated communication apparatus key, and to generate an encrypted shared key of each terminal apparatus that is verified successfully, by encrypting the shared key using a terminal apparatus key of each terminal apparatus that is verified successfully,
wherein the communication device transmits a key reply including the encrypted shared key of the communication apparatus and the encrypted shared key of each terminal apparatus that is verified successfully.

2. (canceled)

3. The key management device according to claim 1,
wherein each response included in the key request is generated by encrypting the challenge included in the key request with using the terminal apparatus key stored in each terminal apparatus, and
wherein the processing circuitry decrypts each response included in the key request into a challenge using each generated terminal apparatus key, compares each decrypted challenge with the challenge included in the key request, and determines a result of verification on each terminal apparatus based on a comparison result.

4. The key management device according to claim 1,
wherein each response included in the key request is an authentication code generated with using the challenge included in the key request and the terminal apparatus key which is stored in each terminal apparatus, and
wherein the processing circuitry generates an authentication code using the challenge included in the key request and each generated terminal apparatus key, compares the generated authentication code with each response included in the key request, and determines a result of verification on each terminal apparatus based on a comparison result.

5. (canceled)

6. (canceled)

7. A communication apparatus comprising:
processing circuitry
to request information from each of one or more terminal apparatuses, and to receive, from the one or more terminal apparatuses, one or more pieces of information,
each received information including a terminal apparatus identifier which identifies a terminal apparatus and a terminal manufacturer identifier which identifies a manufacture of the terminal apparatus,
to arrange the received one or more pieces of information based on a terminal manufacturer identifier included in each information,
to generate a key request, to transmit the key request, and to receive a key reply,
the key request including communication apparatus information, and including, behind the communication apparatus information, terminal apparatus information corresponding to each received information in accordance with an arrangement order of each received information,
the communication apparatus information including a communication apparatus identifier which identifies a communication apparatus, and a communication manufacturer identifier which identifies a manufacturer of the communication apparatus,
each terminal apparatus information including a terminal apparatus identifier in each received information, wherein if a terminal manufacturer identifier of a corresponding terminal apparatus coincides with none of the communication manufacturer identifier and a terminal manufacturer identifier which is included in another terminal apparatus information arranged ahead of each terminal apparatus information in the key request, then each terminal apparatus information includes the terminal manufacturer identifier of the corresponding terminal apparatus, the corresponding terminal apparatus being a terminal apparatus corresponding to said each terminal apparatus information, and wherein if the terminal manufacturer identifier of the corresponding terminal apparatus coincides with either one of the communication manufacturer identifier and a terminal manufacturer identifier Which is included in another terminal apparatus information arranged ahead of each terminal apparatus information in the key request, then each terminal apparatus information does not include the terminal manufacturer identifier of the corresponding terminal apparatus,
the key reply including an encrypted shared key of the communication apparatus and an encrypted shared key of each terminal apparatus,
the encrypted shared key of each terminal apparatus being a key generated by encrypting a shared key with using a terminal apparatus key corresponding to each terminal apparatus identifier,
to decrypt the encrypted shared key, included in the key reply, of the communication apparatus into the shared key using a communication apparatus key corresponding to the communication apparatus identifier, and
to transmit an encrypted shared key, included in the key reply, of each terminal apparatus to each terminal apparatus.

8. (canceled)

9. (canceled)

10. (canceled)

11. The communication apparatus according to claim 7,
wherein the processing circuitry
generates a challenge of challenge response authentication, transmits an information request including the challenge to each terminal apparatus, and receives, from each terminal apparatus, an information reply including information on each terminal apparatus,
information on each terminal apparatus including a response corresponding to the challenge and a terminal apparatus key which is stored in each terminal apparatus, and
transmits the key request,
the key request including the communication apparatus information and each terminal apparatus information,
the communication apparatus information including the challenge,
each terminal apparatus information including a response included in information on the corresponding terminal apparatus.

12. The communication apparatus according to claim 11,
wherein a response included in information on each terminal apparatus is generated by encrypting the challenge included in the information request with using a terminal apparatus key stored in each terminal apparatus.

13. The communication apparatus according to claim 11,
wherein a response included in information on each terminal apparatus is an authentication code generated with using the challenge included in the information request and a terminal apparatus key which is stored in each terminal apparatus.

14. (canceled)

15. (canceled)

16. (canceled)

17. (canceled)

18. (canceled)

19. (canceled)

20. (canceled)

21. (canceled)
